(19) United States
(12) Patent Application Publication
(10) Pub. No.: US 2026/0169200 A1
(43) Pub. Date: Jun. 18, 2026

(54) DISPLAY DEVICE, METHOD FOR MANUFACTURING DISPLAY DEVICE, AND ELECTRONIC APPARATUS INCLUDING DISPLAY DEVICE

(71) Applicant: Samsung Display Co., Ltd., Yongin-si (KR)

(72) Inventor: Jonghwan CHO, Yongin-si (KR)

(73) Assignee: Samsung Display Co., Ltd., Yongin-si (KR)

(21) Appl. No.: 19/352,972

(22) Filed: Oct. 8, 2025

(30) Foreign Application Priority Data
Dec. 17, 2024 (KR) 10-2024-0189035

(51) Int. Cl. G02B 1/14; G02B 1/115; G06F 1/16

(52) U.S. Cl. CPC G02B 1/14; G02B 1/115; G06F 1/1641; G06F 1/1656

(57) ABSTRACT

A display device includes a display module including first to third non-folding portions, first and second folding portions and a protective member on the display module. The protective member may include a hard coating layer. The hard coating layer may include first to fifth portions respectively overlapping the first non-folding portion, the first folding portion, the second non-folding portion, the second folding portion, and the third non-folding portion. The second portion may be formed by a first coating composition, and the fourth portion may be formed by a second coating composition. The first coating composition and the second coating composition may each include a silsesquioxane-based resin, an oxetane-based resin, a cationic photopolymerization initiator, and a silica nanoparticle. A Young's modulus and a hardness of the second portion may be respectively smaller than a Young's modulus and a hardness of the fourth portion.

### CROSS-REFERENCE TO RELATED APPLICATIONS

This U.S. non-provisional patent application claims priority under 35 U.S.C. § 119 of Korean Patent Application No. 10-2024-0189035, filed on Dec. 17, 2024, the entire contents of which are hereby incorporated by reference.

### BACKGROUND

Various electronic apparatuses such as televisions, mobile phones, tablet computers, and/or game consoles have been developed. Recently, flexible electronic apparatuses including a flexible display panel that is capable of folding, rolling, and/or sliding have been developed. Unlike rigid electronic apparatuses, the flexible electronic apparatuses may be folded, rolled, and/or bent. Since the flexible electronic apparatus of which a shape is changeable in various ways may be carried regardless of a conventional screen size, user convenience is improved. The flexible electronic apparatus requires members for maintaining reliability of flexible operation.

### SUMMARY

Some example embodiments provide a display device which exhibits excellent or improved reliability and an electronic apparatus including the same.

Some example embodiments provide a method for manufacturing a display device which exhibits excellent or improved processability.

According to some example embodiments of the inventive concepts, a display device includes a display module including a first non-folding portion, a first folding portion, a second non-folding portion, a second folding portion, and a third non-folding portion in order along one direction; and a protective member on the display module, the protective member including a protective base layer, a hard coating layer on the protective base layer, the hard coating layer including a first portion overlapping the first non-folding portion, a second portion overlapping the first folding portion, a third portion overlapping the second non-folding portion, a fourth portion overlapping the second folding portion, and a firth portion overlapping the third non-folding portion, and an anti-reflection layer on the hard coating layer. The anti-reflection layer including a high refractive layer and a low refractive layer on the high refractive layer, the second portion includes a first polymer derived from a first coating composition, the fourth portion includes a second polymer derived from a second coating composition, each of the first coating composition and the second coating composition includes a silsesquioxane-based resin, an oxetane-based resin, a cationic photopolymerization initiator, and a silica nanoparticle, and a Young's modulus of the second portion and a hardness of the second portion are respectively smaller than a Young's modulus of the fourth portion and a hardness of the fourth portion.

In some example embodiments, each of the Young's modulus of the second portion and the Young's modulus of the fourth portion may be 3 GPa to 6 GPa, and each of the hardness of the second portion and the hardness of the fourth portion may be 0.3 GPa to 0.5 GPa.

In some example embodiments, each of a Young's modulus of the first portion, a Young's modulus of the third portion, and a Young's modulus of the fifth portion may be 6 GPa to 8 GPa, and each of a hardness of the first portion, a hardness of the third portion, and a hardness of the fifth portion may be 0.8 GPa to 1.0 GPa.

In some example embodiments, the display device may be configured to be folded in a first mode such that the first folding portion is out-folded and the second folding portion is in-folded, and the first non-folding portion, the second non-folding portion, and the third non-folding portion overlap, and the display device is configured to be unfolded in a second mode such that the first non-folding portion, the second non-folding portion, and the third non-folding portion are aligned.

In some example embodiments, in the first coating composition, a first weight of the silsesquioxane-based resin may be smaller than a second weight of the oxetane-based resin, and in the second coating composition, a third weight of the silsesquioxane-based resin may be greater than a fourth weight of the oxetane-based resin.

In some example embodiments, a ratio of the first weight to the second weight may be 2:8 to 4:6.

In some example embodiments, a ratio of the third weight to the fourth weight may be 6:4 to 8:2.

In some example embodiments, based on 100 wt % of a total weight of the first coating composition, a sum of the first weight of the silsesquioxane-based resin and the second weight of the oxetane-based resin may be 93 wt % to 95 wt %, and based on 100 wt % of a total weight of the second coating composition, a sum of the third weight of the silsesquioxane-based resin and the fourth weight of the oxetane-based resin may be 93 wt % to 95 wt %.

In some example embodiments, the first portion, the third portion, and the fifth portion may each include a third polymer derived from a third coating composition, and the third coating composition may include the silsesquioxane-based resin, a polymer resin including a radical photopolymerization functional group, a radical photopolymerization initiator, and the silica nanoparticle.

In some example embodiments, the polymer resin including the radical photopolymerization functional group may include at least one among pentaerythritol tetraacrylate, trimethylolpropane trimethacrylate, and ethylene oxide-modified isocyanurate diacrylate, and the radical photopolymerization initiator may include diphenyl(2,4,6-trimethylbenzoyl phosphine) oxide.

In some example embodiments, based on 100 wt % of a total weight of the third coating composition, a sum of a weight of the silsesquioxane-based resin and a weight of the polymer resin including the radical photopolymerization functional group may be 93 wt % to 95 wt %.

In some example embodiments, the silsesquioxane-based resin may include at least one among a partial cage structure, a ladder structure, a random structure, a T₈ cage structure, a T₁₀ cage structure, or a T₁₂ cage structure.

In some example embodiments, the oxetane-based resin may include at least one among 1,4-bis[(3-ethyl-3-oxetanylmethoxy)methyl]benzene or 2-ethylhexyloxetane, and the cationic photopolymerization initiator may include triarylsulfonium hexafluoroantimonate salt.

In some example embodiments, based on 100 wt % of a total weight of the first coating composition, a weight of the cationic photopolymerization initiator may be 2 wt % or less, and a weight of the silica nanoparticle may be 3 wt % to 5 wt %, and based on 100 wt % of a total weight of the second coating composition, a weight of the cationic photopolymerization initiator may be 2 wt % or less, and a weight of the silica nanoparticle may be 3 wt % to 5 wt %.

In some example embodiments, the silica nanoparticle may have a diameter of 20 nm to 60 nm.

In some example embodiments of the inventive concepts, a method for manufacturing a display device includes preparing a display module in which a first non-folding portion, a first folding portion, a second non-folding portion, a second folding portion, and a third non-folding portion are in order one direction; and providing a protective member on the display module by preparing a protective base layer, providing, on the protective base layer, a hard coating layer having a first portion formed by providing a first coating composition, the first portion overlapping the first non-folding portion, a second portion formed by providing a second coating composition, the second portion overlapping the first folding portion, a third portion formed by providing the first coating composition, the third portion overlapping the second non-folding portion, a fourth portion formed by providing a third coating composition, the fourth portion overlapping the second folding portion, and a fifth portion formed by providing the first coating composition, the fifth portion overlapping the third non-folding portion, and providing, on the hard coating layer, an anti-reflection layer having a high refractive layer and a low refractive layer on the high refractive layer, each of the second coating composition and the third coating composition includes a silsesquioxane-based resin, an oxetane-based resin, a cationic photopolymerization initiator, and a silica nanoparticle, the first coating composition, the second coating composition and the third coating composition are provided in a same operation, and a Young's modulus of the second portion and a hardness of the second portion are respectively smaller than a Young's modulus of the fourth portion and a hardness of the fourth portion.

In some example embodiments, the first coating composition, the second coating composition and the third coating composition may be provided by a slit coating method.

In some example embodiments, in the first coating composition a first weight of the silsesquioxane-based resin may be smaller than a second weight of the oxetane-based resin, and in the second coating composition, a third weight of the silsesquioxane-based resin may be greater than a fourth weight of the oxetane-based resin.

In some example embodiments, the first coating composition may include the silsesquioxane-based resin, a polymer resin including a radical photopolymerization functional group, a radical photopolymerization initiator, and the silica nanoparticle.

In some example embodiments of the inventive concepts, an electronic apparatus includes a housing; and a display device including at least a portion in the housing, a display module including a first non-folding portion, a first folding portion, a second non-folding portion, a second folding portion, and a third non-folding portion in order along one direction, and a protective member on the display module, the protective member including a protective base layer, a hard coating layer on the protective base layer, the hard coating layer including a first portion overlapping the first non-folding portion, a second portion overlapping the first folding portion, a third portion overlapping the second non-folding portion, a fourth portion overlapping the second folding portion, and a firth portion overlapping the third non-folding portion, and an anti-reflection layer on the hard coating layer, the anti-reflection layer including a high refractive layer and a low refractive layer on the high refractive layer, the second portion includes a first polymer derived from a first coating composition, the fourth portion includes a second polymer derived from a second coating composition, each of the first coating composition and the second coating composition includes a silsesquioxane-based resin, an oxetane-based resin, a cationic photopolymerization initiator, and a silica nanoparticle, and a Young's modulus of the second portion and a hardness of the second portion are respectively smaller than a Young's modulus of the fourth portion and a hardness of the fourth portion.

### BRIEF DESCRIPTION OF THE FIGURES

The accompanying drawings are included to provide a further understanding of the inventive concepts, and are incorporated in and constitute a part of this specification. The drawings illustrate some example embodiments of the inventive concepts and, together with the description, serve to explain principles of the inventive concepts. In the drawings:

FIG. 1A is a perspective view illustrating an electronic apparatus according to some example embodiments;

FIG. 1B is a perspective view illustrating an electronic apparatus according to some example embodiments;

FIG. 1C is a perspective view illustrating an electronic apparatus according to some example embodiments;

FIG. 2 is a block diagram of an electronic apparatus according to some example embodiments;

FIG. 3 illustrates an electronic apparatus according to some example embodiments;

FIG. 4 is an exploded perspective view illustrating an electronic apparatus according to some example embodiments;

FIG. 5 is a cross-sectional view taken along line I-I′ of FIG. 4;

FIG. 6 is a cross-sectional view illustrating a portion of an electronic apparatus according to some example embodiments;

FIG. 7 illustrates a silica nanoparticle according to some example embodiments;

FIG. 8 is a cross-sectional view taken along line II-II′ of FIG. 4;

FIG. 9A is a flowchart illustrating a method for manufacturing a display device according to some example embodiments;

FIG. 9B is a flowchart illustrating a method for manufacturing a display device according to some example embodiments; and

FIG. 10 schematically illustrates a manufacturing step of a display device according to some example embodiments.

### DETAILED DESCRIPTION

The inventive concepts may be implemented in various modifications and have various forms, and some example embodiments are illustrated in the drawings and described in detail in the text. It is to be understood, however, that the inventive concepts are not intended to be limited to the particular forms disclosed, but on the contrary, are intended to cover all modifications, equivalents, and/or alternatives falling within the spirit and scope of the inventive concepts.

In this specification, it will be understood that when an element (or a region, a layer, a portion, and/or the like) is referred to as being “on”, “connected to” or “coupled to” another element, it may be directly disposed on, connected to, and/or coupled to the other element, or other elements may be disposed therebetween.

Like reference numerals or symbols refer to like elements throughout. Also, in the drawings, the thickness, ratio, and size of the elements are exaggerated for effectively describing the technical contents. As used herein, the term “and/or” includes any and all combinations of one or more of the associated listed elements.

It will be understood that, although the terms “first”, “second”, etc. may be used herein to describe various elements, the elements are not to be limited by these terms. These terms are only used to distinguish one element from another element. For instance, a first element discussed below could be termed a second element without departing from the scope of the inventive concepts. Similarly, a second element could be termed a first element. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, and/or the like may be used to describe the relationships between the elements illustrated in the drawings. These terms have relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components, and/or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skills in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In this specification, an alkyl group may be linear, branched, or cyclic. The number of carbon atoms of the alkyl group may be 1 to 60, 1 to 50, 1 to 30, 1 to 20, 1 to 10, or 1 to 6. Examples of the alkyl group may include a methyl group, an ethyl group, an n-propyl group, an isopropyl group, a cyclopropyl group, an n-butyl group, an s-butyl group, a t-butyl group, an i-butyl group, a 2-ethylbutyl group, a 3,3-dimethylbutyl group, a cyclobutyl group, an n-pentyl group, an i-pentyl group, a neopentyl group, a t-pentyl group, a 1-methylpentyl group, a 3-methylpentyl group, a 2-ethylpentyl group, a 4-methyl-2-pentyl group, a cyclopentyl group, an n-hexyl group, a 1-methylhexyl group, a 2-ethylhexyl group, a 2-butylhexyl group, a cyclohexyl group, a 4-methylcyclohexyl group, a 4-butylcyclohexyl group, an n-heptyl group, a 1-methylheptyl group, a 2,2-dimethylheptyl group, a 2-ethylheptyl group, a 2-butylheptyl group, a cycloheptyl group, a bicycloheptyl group, an n-octyl group, a t-octyl group, a 2-ethyloctyl group, a 2-butyloctyl group, a 2-hexyloctyl group, a 3,7-dimethyloctyl group, a cyclooctyl group, an n-nonyl group, a cyclononyl group, an n-decyl group, a cyclodecyl group, a norbornyl group, a 1-adamantyl group, a 2-adamantyl group, an isobornyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldodecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-icosyl group, a 2-ethyleicosyl group, a 2-butyleicosyl group, a 2-hexyleicosyl group, a 2-octyleicosyl group, an n-henicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, an n-triacontyl group, and/or the like, but are not limited thereto.

In this specification, an alkenyl group represents a hydrocarbon group containing one or more carbon double bond in a middle or end of the alkyl group with 2 or more carbon atoms. The alkenyl group may be linear or branched. The number of carbon atoms of the alkenyl group is not particularly limited, but the number may be 2 to 60, 2 to 30, 2 to 20, or 2 to 10. Examples of the alkenyl group include a vinyl group, a 1-butenyl group, a 1-pentenyl group, a 1,3-butadienyl aryl group, a styrenyl group, a styrylvinyl group, etc., but are not limited thereto.

In this specification, an aryl group refers to any functional group or substituent derived from an aromatic hydrocarbon ring. The aryl group may be a monocyclic aryl group or polycyclic aryl group. The number of ring-forming carbon atoms of the aryl group may be 6 to 60, 6 to 30, 6 to 20, or 6 to 15. Examples of the aryl group include a phenyl group, a naphthyl group, a fluorenyl group, an anthracenyl group, a phenanthryl group, a biphenyl group, a terphenyl group, a quarterphenyl group, a quinquephenyl group, a sexiphenyl group, a triphenylenyl group, a pyrenyl group, a benzofluoranthenyl group, a chrysenyl group, etc., but are not limited thereto.

In this specification, an alkoxy group may represent that an oxygen atom is bonded to the alkyl group defined above. The alkoxy group may be linear, branched, or cyclic. The number of carbon atoms of the alkoxy group is not particularly limited, but for example, the number may be 1 to 60, 1 to 30, 1 to 20, or 1 to 10. Examples of the alkoxy group include methoxy, ethoxy, n-propoxy, isopropoxy, butoxy, pentyloxy, hexyloxy, octyloxy, nonyloxy, decyloxy, etc., but are not limited thereto.

In this specification, *— means a position to be bonded.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%. Further, regardless of whether numerical values or shapes are modified as “about” or “substantially,” it will be understood that these values and shapes should be construed as including a manufacturing or operational tolerance (e.g., ±10%) around the stated numerical values or shapes.

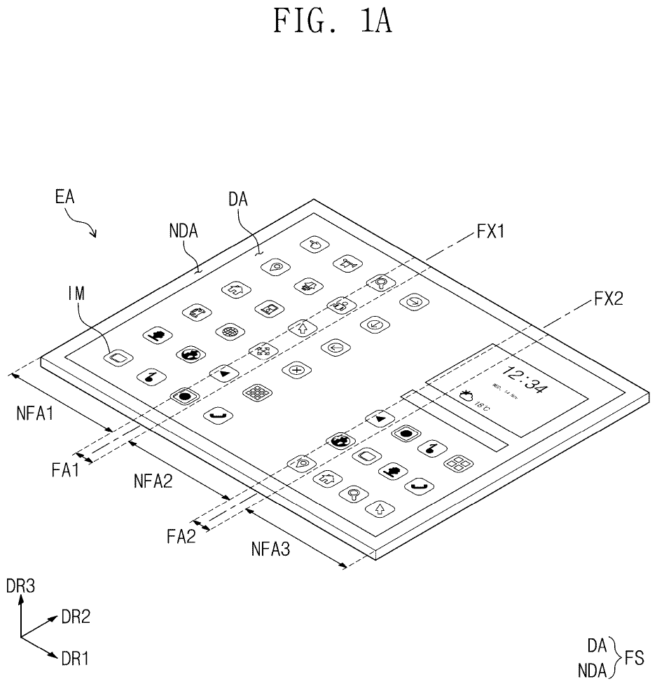

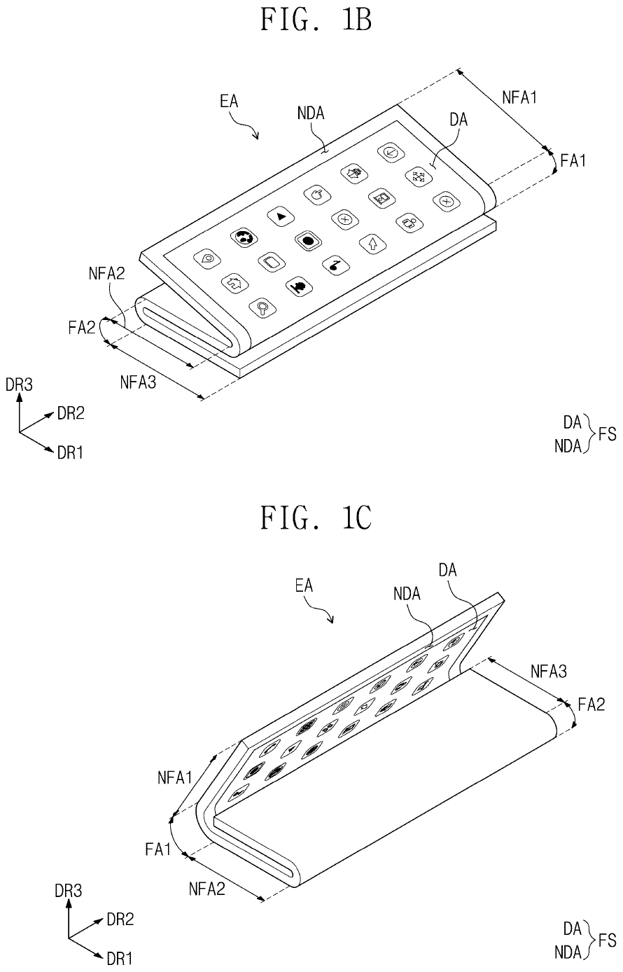

Hereinafter, a display device and an electronic apparatus including the same according to some example embodiments of the inventive concepts are described with reference to the drawings. FIGS. 1A to 1C are perspective views illustrating an electronic apparatus according to some example embodiments.

An electronic apparatus EA according to some example embodiments may be activated in response to an electrical signal. For example, the electronic apparatus EA may be a personal computer, laptop computer, personal digital terminal, game console, portable electronic device, television, monitor, outdoor billboard, car navigation system, and/or wearable device, but some example embodiments of the inventive concepts are not limited thereto. FIG. 1A illustrates, as an example, that the electronic apparatus EA is a portable electronic device.

The electronic apparatus EA may include a display surface FS defined by a first direction axis DR1 and a second direction axis DR2 crossing the first direction axis DR1. The electronic apparatus EA may provide an image IM to a user through the display surface FS. The electronic apparatus EA may display the image IM toward a third direction axis DR3 on the display surface FS that is parallel to each of the first direction axis DR1 and the second direction axis DR2. The image IM may include a dynamic image and/or a static image.

Directions indicated by the first to third direction axes DR1, DR2, and DR3 which are described in this specification may have a relative concept and may thus be changed to other directions. In addition, the directions indicated by the first to third direction axes DR1, DR2, and DR3 may be respectively described as first to third directions, and may thus be denoted as the same reference numerals or symbols.

In this specification, the first direction axis DR1 and the second direction axis DR2 may be perpendicular to each other, and the third direction axis DR3 may be a normal direction with respect to a plane defined by the first direction axis DR1 and the second direction axis DR2. A thickness direction of the electronic apparatus EA may be a direction parallel to the third direction axis DR3. The thickness direction of the electronic apparatus EA may be denoted as the same reference numeral or symbol as the third direction axis DR3. A front surface (or top surface) and a rear surface (or bottom surface) may be opposed to each other in the third direction axis DR3, and a normal direction of each of the front surface (or top surface) and the rear surface (or bottom surface) may be parallel to the third direction axis DR3. The front surface (or top surface) refers to a surface adjacent to the display surface FS, and the rear surface (or bottom surface) refers to a surface spaced apart from the display surface FS. An upper side refers to a direction closer to the display surface FS and a lower side refers to a direction away from the display surface FS.

In this specification, a cross section refers to a surface parallel to the thickness direction DR3. A planar surface refers to a surface that is perpendicular to the thickness direction DR3, and parallel to a plane defined by the first direction axis DR1 and the second direction axis DR2.

In this specification, the wording “a component overlaps another component” means “overlapping on a plane”. In addition, the wording “a component overlaps another component” is not limited to a case where a component and another component have the same area and the same shape, and also includes a case where the components have different areas and/or different shapes.

The electronic apparatus EA may sense an external input applied from the outside. The external input may include various types of inputs provided from the outside of the electronic apparatus EA. For instance, the external input may include not only a touch by a user's body part such as a hand but also an external input (for example, hovering) applied by approaching or becoming adjacent to the electronic apparatus EA at a setting distance. For example, the external input may have various types such as force, pressure, temperature, and/or light.

The display surface FS may include a display region DA and/or a non-display region NDA. The display region DA may be activated in response to an electrical signal. The display region DA may be a region where the image IM is displayed, and various types of external inputs may be sensed.

The display region DA may include a planar surface defined by the first direction axis DR1 and the second direction axis DR2. However, this is an example, and the shape of the display region DA is not limited thereto. For example, the display region DA may include a curved surface bent from at least one side of the planar surface defined by the first direction axis DR1 and the second direction axis DR2. The display region DA may further include two or more curved surfaces, for example, four curved surfaces respectively bent from four sides of the planar surface defined by the first direction axis DR1 and the second direction axis DR2.

The non-display region NDA may be adjacent to the display region DA. Light transmittance of the non-display region NDA may be lower than light transmittance of the display region DA. The non-display region NDA may not be optically transparent and have a color. The non-display region NDA may surround the display region DA. Accordingly, the shape of the display region DA may be substantially defined by the non-display region NDA. However, this is an example, and the non-display region NDA may also be disposed adjacent to only one side of the display region DA, or may be omitted.

The electronic apparatus EA according to some example embodiments may be flexible. The wording “flexible” refers to a bendable property, and may include from a structure that is completely folded to a structure that is bendable to a level of several nanometers. For example, the electronic apparatus EA may be a foldable apparatus. Alternatively, the electronic apparatus EA may be a rigid apparatus.

The electronic apparatus EA according to some example embodiments may include a plurality of folding regions FA1 and/or FA2 and/or a plurality of non-folding regions NFA1, NFA2, and/or NFA3 extending from the folding regions FA1 and/or FA2. For example, a first non-folding region NFA1, a first folding region FA1, a second non-folding region NFA2, a second folding region FA2, and/or a third non-folding region NFA3 may be defined along the first direction DR1. The electronic apparatus EA according to some example embodiments may include the first non-folding region NFA1, the second non-folding region NFA2, and/or the third non-folding region NFA3 spaced apart from one another in the first direction DR1 with the first and/or second folding region FA1 and/or FA2 therebetween. For example, the first non-folding region NFA1 may be disposed at one side of the first folding region FA1 along the first direction DR1, and the second non-folding region NFA2 may be disposed at the other side of the first folding region FA1 along the first direction DR1. For example, the second non-folding region NFA2 may be disposed at one side of the second folding region FA2 along the first direction DR1, and the third non-folding region NFA3 may be disposed at the other side of the second folding region FA2 along the first direction DR1.

Some example embodiments in which the electronic apparatus EA includes two folding regions FA1 and FA2 are illustrated in FIG. 1A, and the like, but some example embodiments of the inventive concepts are not limited thereto. Three or more folding regions may be defined in the electronic apparatus EA. For instance, the electronic apparatus according to some example embodiments may include three or more folding regions, and may also include four or more non-folding regions disposed with each of the folding regions therebetween.

In first and/or third modes, the electronic apparatus EA may be folded such that the first to third non-folding regions NFA1, NFA2, and NFA3 overlap. In a second mode, the electronic apparatus EA may be unfolded such that the first to third non-folding regions NFA1, NFA2, and NFA3 are aligned. The first and third modes may be a folding mode. The second mode may be a non-folding mode. FIG. 1A may illustrate the electronic apparatus EA in the second mode. FIG. 1B may illustrate the electronic apparatus EA in the first mode. FIG. 1C may illustrate the electronic apparatus EA in the third mode. There may be a difference in a folding direction of the first folding region FA1 between the first mode and the third mode. The first and second folding regions FA1 and FA2 may each be in-folded or out-folded depending on a folding direction. FIGS. 1B and 1C are perspective views illustrating a folding operation of the electronic apparatus EA according to some example embodiments.

Referring to FIGS. 1A and 1B, the first folding region FA1 may be folded with respect to a first folding axis FX1 that is parallel to the second direction DR2. The first folding region FA1 may be out-folded such that a rear surface of the second non-folding region NFA2 and a rear surface of the first non-folding region NFA1 face each other, and a front surface of the first non-folding region NFA1 faces the outside. The front surface of the first non-folding region NFA1 may be a portion of the display surface FS, and may be visible to a user. The second folding region FA2 may be folded with respect to a second folding axis FX2 that is parallel to the second direction DR2. The second folding region FA2 may be in-folded such that a front surface of the second non-folding region NFA2 and a front surface of the third non-folding region NFA3 face each other. Only a portion of the display surface FS may be exposed to the outside in the first mode where the first folding region FA1 is out-folded, and the second folding region FA2 is in-folded.

Referring to FIGS. 1A and 1C, the second folding region FA2 may be in-folded with respect to the second folding axis FX2 that is parallel to the second direction DR2. The second folding region FA2 may be in-folded such that the front surface of the second non-folding region NFA2 and the front surface of the third non-folding region NFA3 face each other. The first folding region FA1 may be in-folded with respect to the first folding axis FX1 that is parallel to the second direction DR2. The first folding region FA1 may be in-folded such that the rear surface of the third non-folding region NFA3 and the front surface of the first non-folding region NFA1 face each other, and the rear surface of the first non-folding region NFA1 faces the outside. The display surface FS may not be exposed to the outside in the third mode where both the first and second folding regions FA1 and FA2 are in-folded. FIG. 1C illustrates, as an example, that the first folding region FA1 is folded after the second folding region FA2 is folded, but a folding order of the folding regions FA1 and FA2 is not limited thereto. For example, the second folding region FA2 may also be folded after the first folding region FA1 is folded.

A multi-folded state is not limited to the shapes illustrated in FIGS. 1B and 1C, and may include various folding shapes. In some example embodiments, an out-folding operation and an in-folding operation may occur simultaneously, and only one operation of the out-folding operation or the in-folding operation may also occur.

The electronic apparatus EA according to some example embodiments may be configured such that the in-folding or out-folding operations may be alternately repeated from the unfolding operation, but some example embodiments of the inventive concepts are not limited thereto. The electronic apparatus EA according to some example embodiments may be configured to select any one among the unfolding operation, in-folding operation, and out-folding operation.

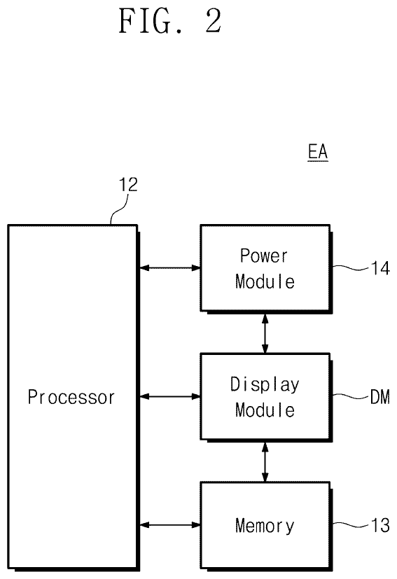

FIG. 2 is a block diagram of an electronic apparatus according to some example embodiments. Referring to FIG. 2, an electronic apparatus EA according to some example embodiments may include a display module DM, a processor 12, a memory 13, and/or a power module 14.

The processor 12 may include at least one among a central processing unit (CPU), an application processor (AP), a graphic processing unit (GPU), a communication processor (CP), an image signal processor (ISP), and/or a controller. The power module 14 may include a power supply module such as a power adapter and/or battery unit, and/or a power conversion module which converts the power provided by the power supply module and generates power, sufficient or necessary for an operation of the electronic apparatus EA.

Data information that is necessary or sufficient for an operation of the processor 12 and/or the display module DM may be stored in the memory 13. When the processor 12 executes an application stored in the memory 13, an image data signal and/or an input control signal may be transmitted to the display module DM, and thus the display module DM may output image information through a display screen by processing the received signal.

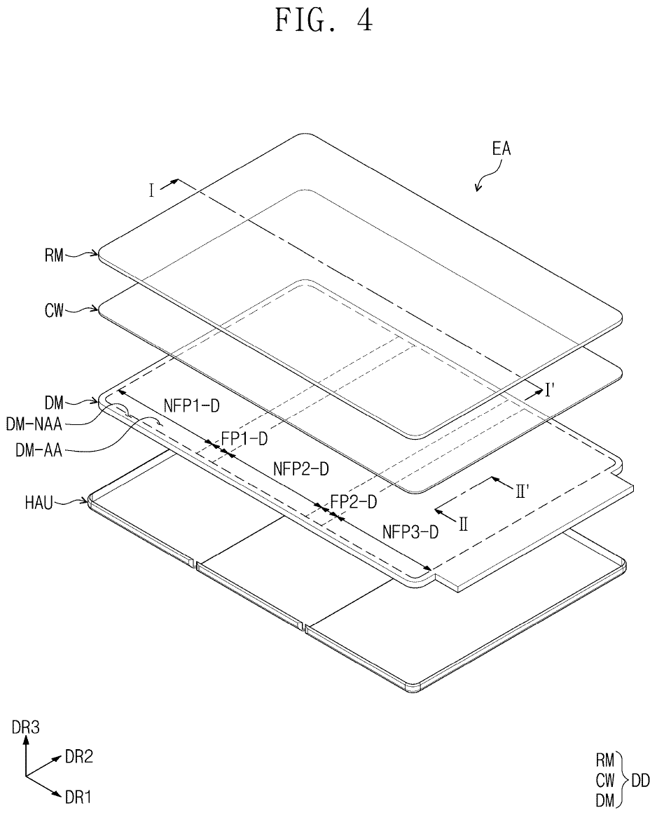

At least one of the components of the electronic apparatus EA may be included within a display device DD (see FIG. 4) according to some example embodiments. For example, among the components of the electronic apparatus EA, some of the individual modules that are functionally included within one module may be included within the display device DD (see FIG. 4), and others may be provided separately from the display device DD (see FIG. 4). For example, the display device DD (see FIG. 4) may include the display module DM, and/or the processor 12, the memory 13, and/or the power module 14 may be provided in a form of another device within the electronic apparatus EA rather than the display device DD (see FIG. 4).

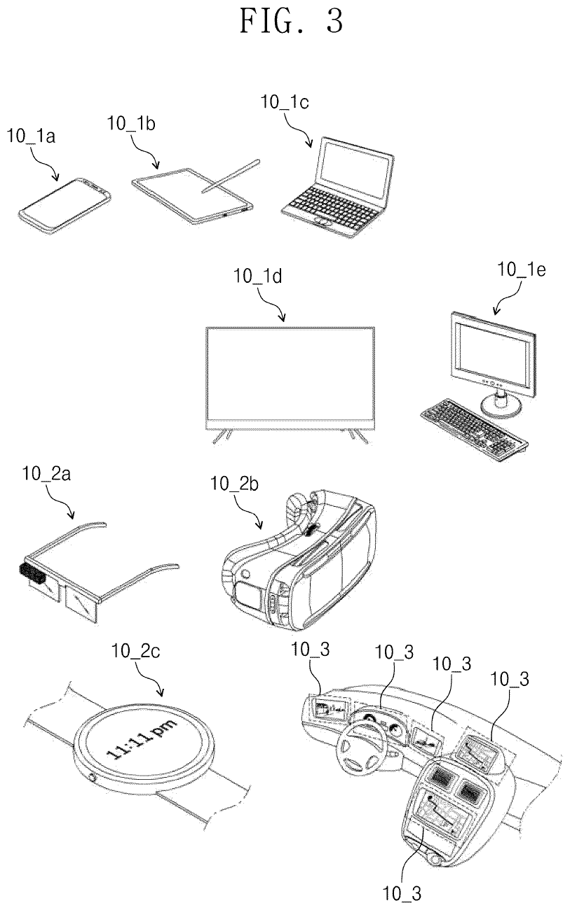

FIG. 3 is a schematic diagram illustrating an electronic apparatus according to some example embodiments. Referring to FIG. 3, an electronic apparatus EA including a display device DD (see FIG. 4) according to some example embodiments may include not only an electronic apparatus, for displaying an image, such as a smart phone 10_1a, a tablet PC 10_1b, a laptop computer 10_1c, a TV 10_1d, and/or a monitor for a desk 10_1e, but also a wearable electronic apparatus, including the display module DM (see FIG. 2), such as smart glasses 10_2a, a head-mounted display 10_2b, and/or a smart watch 10_2c, and/or an electronic apparatus for vehicles 10_3, including the display module DM (see FIG. 2), such as a room mirror display and/or a center information display (CID), which is disposed on a car's instrument cluster, center fascia, and/or dashboard.

FIG. 4 is an exploded perspective view illustrating the electronic apparatus EA illustrated in FIG. 1A. Referring to FIG. 4, the electronic apparatus EA may include a display device DD and/or a housing HAU where at least a portion of the display device DD is accommodated.

In some example embodiments, the display device DD may include a display module DM and/or a protective member RM disposed on the display module DM. The display device DD may further include a window CW disposed between the display module DM and the protective member RM.

The image IM (see FIG. 1) generated in the display module DM may pass through the window CW and/or the protective member RM to be provided to a user. The protective member RM may be folded with respect to the first and second folding axes FX1 and FX2 (see FIG. 1A). The protective member RM according to some example embodiments may reduce or prevent damage such as a crack during low curvature folding and exhibit a property that facilitates a repetition of folding and unfolding by including a hard coating layer HAC and/or an anti-reflection layer ARL to be described later. The low curvature folding may refer to folding with a small radius of curvature of about 2.0 mm or less or about 1.6 mm or less. Accordingly, the display device DD including the protective member RM according to some example embodiments and the electronic apparatus EA including the same may exhibit excellent or improved reliability.

The display module DM may display an image according to an electrical signal, and may transmit/receive information about an external input. An active region DM-AA and/or a peripheral region DM-NAA may be defined in the display module DM.

The active region DM-AA may be defined as a region where an image provided by the display module DM is output. The active region DM-AA of the display module DM may correspond to at least a portion of the display region DA (see FIG. 1A).

A driving circuit, driving wiring, and/or the like for driving the active region DM-AA may be disposed in the peripheral region DM-NAA. The peripheral region DM-NAA may be adjacent to the active region DM-AA. For example, the peripheral region DM-NAA may surround the active region DM-AA. However, this is an example, and the peripheral region DM-NAA may be defined to have various shapes and is not limited to any one embodiment.

In the display module DM, a first non-folding portion NFP1-D, a first folding portion FP1-D, a second non-folding portion NFP2-D, a second folding portion FP2-D, and/or a third non-folding portion NFP3-D may be defined along a second direction DR2. The first and second folding portions FP1-D and FP2-D may be the portions respectively corresponding to the first and second folding regions FA1 and FA2 (see FIG. 1A). The first to third non-folding portions NFP1-D, NFP2-D, and NFP3-D may be the portions respectively corresponding to the first to third non-folding regions NFA1, NFA2, and NFA3 (see FIG. 1A).

The first folding portion FP1-D may be a portion that is folded with respect to the first folding axis FX1 (see FIG. 1A). The first non-folding portion NFP1-D and the second non-folding portion NFP2-D may be spaced apart from each other with the first folding portion FP1-D therebetween. The second folding portion FP2-D may be a portion that is folded with respect to the second folding axis FX2 (see FIG. 1A). The second non-folding portion NFP2-D and the third non-folding portion NFP3-D may be spaced apart from each other with the second folding portion FP2-D therebetween. In a first mode, the display device DD may be folded such that the first to third non-folding portions NFP1-D, NFP2-D, and NFP3-D overlap. In the first mode, the first folding portion FP1-D may be out-folded, and the second folding portion FP2-D may be in-folded. In a second mode, the display device DD may be unfolded such that the first to third non-folding portions NFP1-D, NFP2-D, and NFP3-D may be aligned on a plane.

The housing HAU may include a material with relatively high rigidity. For instance, the housing HAU may include a plurality of frames and/or plates composed of glass, plastic, or metal. The housing HAU may provide an accommodation space. The display module DM of the display device DD may be accommodated within the accommodation space to be protected from an external impact.

The window CW may be optically transparent. For example, the window CW may be a tempered glass substrate. The window CW may be an ultra-thin tempered glass substrate. The window CW may have flexibility to easily change states by folding or bending.

Although not illustrated, the electronic apparatus EA may further include at least one adhesive layer. For example, the adhesive layer may be disposed between the display module DM and the window CW and/or between the window CW and the protective member RM. The adhesive layer may include a pressure sensitive adhesive (PSA), an optically clear adhesive (OCA) film, and/or an optically clear adhesive resin (OCR) layer. However, this is an example, and some example embodiments of the inventive concepts are not limited thereto.

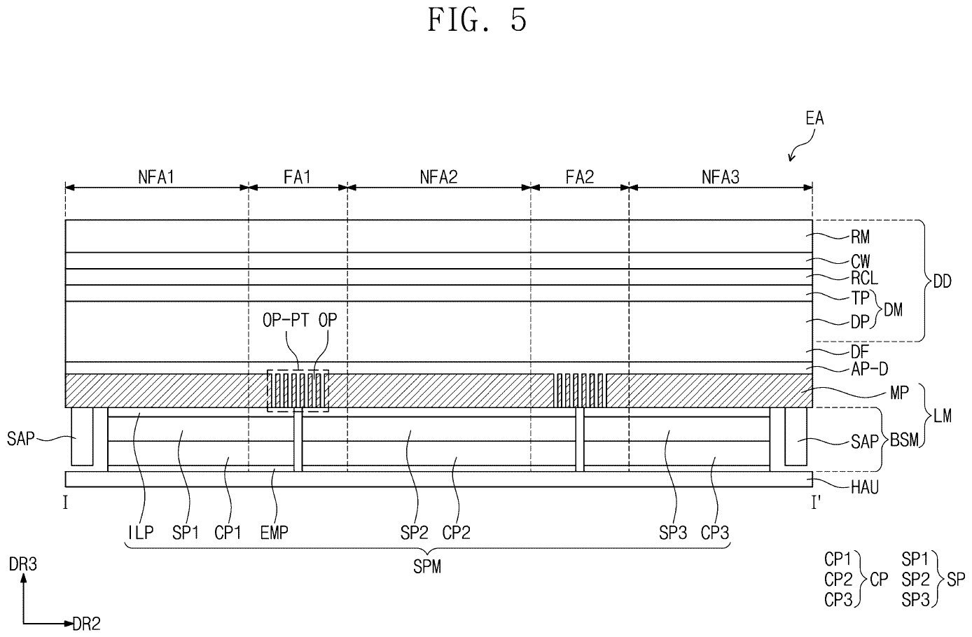

FIG. 5 is a cross-sectional view taken along line I-I′ of FIG. 4. In FIG. 5, for convenience of explanation, housing HAU is schematically illustrated.

Referring to FIG. 5, the electronic apparatus EA may further include a lower module LM, a lower adhesive layer AP-D, and/or a lower protective film DF. The lower module LM, the lower adhesive layer AP-D, and/or the lower protective film DF may be disposed between a display device DD and the housing HAU.

The lower module LM may be disposed under a display module DM. The lower module LM may include a support plate MP and/or a lower support member BSM. A configuration of the lower module LM illustrated in FIG. 5 is an example, and a combination of components included in the lower module LM of the electronic apparatus EA according to some example embodiments may vary depending on a size of the electronic apparatus EA, a shape of the electronic apparatus EA, an operating property of the electronic apparatus EA, and/or the like.

The support plate MP may include a metal material and/or a polymer material. For example, the support plate MP may be formed by including stainless steel, aluminum, and/or an alloy thereof. For example, the support plate MP may be formed from a polymer material. A plurality of openings OP may be defined in the support plate MP. The support plate MP may include an opening pattern OP-PT where the plurality of openings OP are defined. For instance, two opening patterns OP-PT may be formed so as to respectively overlap a first folding region FA1 and a second folding region FA2.

The lower support member BSM may include a support member SPM and/or a charging part SAP. On a plane, the support member SPM may be a component overlapping most regions of the display module DM. The charging part SAP may be a component disposed outside the support member SPM and overlapping an edge of the display module DM.

The support member SPM may include at least one among a support layer SP, a cushion layer CP, a shielding layer EMP, and/or an interlayer bonding layer ILP. A configuration of the support member SPM illustrated in FIG. 5 is an example, and some example embodiments of the inventive concepts are not limited thereto. For example, some of the support layer SP, the cushion layer CP, the shielding layer EMP, and/or the interlayer bonding layer ILP may be omitted, or a stacking sequence thereof may be changed to a sequence different from that of FIG. 5. For example, the support member SPM may further include an additional component other than the components illustrated.

The support layer SP may include a metal material and/or a polymer material. The support layer SP may be disposed under the support plate MP. For example, the support layer SP may be a thin-film metal substrate. The support layer SP may include first to third sub-support layers SP1, SP2, and/or SP3 which are spaced apart in a second direction DR2. The first sub-support layer SP1 and the second sub-support layer SP2 may be spaced apart in a portion corresponding to the first folding axis FX1 (see FIG. 1A). The second sub-support layer SP2 and the third sub-support layer SP3 may be spaced apart in a portion corresponding to the second folding axis FX2 (see FIG. 1A). The first sub-support layer SP1 and the third sub-support layer SP3 may be spaced apart in the second direction DR2 with the second sub-support layer SP2 therebetween. Since the support layer SP is provided as the first to third sub-support layers SP1, SP2, and/or SP3 which are spaced apart in the first and second folding regions FA1 and FA2, the folding property of the electronic apparatus EA may be improved.

The cushion layer CP may be disposed under the support layer SP. The cushion layer CP may reduce or prevent a pressed phenomenon and plastic deformation of the support plate MP due to an external impact and force. The cushion layer CP may improve impact resistance of the electronic apparatus EA. The cushion layer CP may include a sponge, foam, elastomer such as urethane resin, or the like. In addition, the cushion layer CP may be formed by including at least one among an acrylate-based polymer, a urethane-based polymer, a silicon-based polymer, and an imide-based polymer. However, this is an example, and an embodiment of the inventive concept is not limited thereto.

The cushion layer CP may include first to third sub-cushion layers CP1, CP2, and/or CP3 which are spaced apart in the second direction DR2. The first sub-cushion layer CP1 and the second sub-cushion layer CP2 may be spaced apart from each other in a portion corresponding to the first folding axis FX1 (see FIG. 1A). The second sub-cushion layer CP2 and the third sub-cushion layer CP3 may be spaced apart from each other in a portion corresponding to the second folding axis FX2 (see FIG. 1A). The first sub-cushion layer CP1 and the third sub-cushion layer CP3 may be spaced apart in the second direction DR2 with the second sub-cushion layer CP2 therebetween. Since the cushion layer CP is provided as the first to third sub-cushion layers CP1, CP2, and/or CP3 which are spaced apart in the first and second folding regions FA1 and FA2, the folding property of the electronic apparatus EA may be improved.

The shielding layer EMP may be an electromagnetic wave shielding layer or a heat dissipation layer. For example, the shielding layer EMP may function as a bonding layer.

The interlayer bonding layer ILP may bond the support plate MP and the components of the support member SPM. The interlayer bonding layer ILP may be provided in the form of a bonding resin layer and/or adhesive tape. In FIG. 5, it is illustrated that the interlayer bonding layer ILP is provided as three components spaced apart in portions corresponding to the first and second folding axes FX1 and FX2 (see FIG. 1A), however, example embodiments of the inventive concepts are not limited thereto. Unlike what is illustrated, the interlayer bonding layer ILP may be provided as one layer that is not spaced apart in regions corresponding to the first and second folding axes FX1 and FX2 (see FIG. 1A).

The charging part SAP may be disposed outside the support layer SP and the cushion layer CP. The charging part SAP may be disposed between the support plate MP and the housing HAU. The charging part SAP may fill the space between the support plate MP and the housing HAU, and may fix the support plate MP.

The lower protective film DF may be disposed between the display module DM and the support plate MP. The lower protective film DF may be a component which is disposed under the display module DM to protect a rear surface of the display module DM. The lower protective film DF may entirely overlap the display module DM. The lower protective film DF may contain a polymer material. For example, the lower protective film DF may be a polyimide film and/or a polyethyleneterephthalate film. However, this is an example, and the lower protective film DF is not limited thereto.

The lower adhesive layer AP-D may be disposed between the support plate MP and the lower protective film DF. The support plate MP and the lower protective film DF may be coupled through the lower adhesive layer AP-D. The lower adhesive layer AP-D may include a pressure sensitive adhesive (PSA), an optically clear adhesive (OCA) film, and/or an optically clear adhesive resin (OCR) layer. However, this is an example, and some example embodiments of the inventive concepts are not limited thereto. Unlike what is illustrated, the lower adhesive layer AP-D may be omitted.

The display module DM may include a display panel DP and/or an input-sensing part TP disposed on the display panel DP. The display panel DP may be a component substantially generating an image. The display panel DP according to some example embodiments may be folded with respect to the folding axes FX1 and FX2 (see FIG. 1A).

The input-sensing part TP may sense an external input and change the input into a setting input signal, and thus provide the input signal to the display panel DP. For example, the input-sensing part TP may be a touch sensing part which detects a touch. The input-sensing part TP may recognize a user's direct touch, a user's indirect touch, a direct touch of an object, an indirect touch of an object, and/or the like.

The input input-sensing part TP may detect at least one among a location of a touch applied from the outside and strength (pressure) of a touch. In some example embodiments, the input-sensing part TP may have various structures and/or may be composed of various materials, and is not limited to any one example embodiment. For example, the input-sensing part TP may detect an external input in a capacitive manner. The display panel DP may receive an input signal from the input-sensing part TP, and may generate an image corresponding to the input signal.

The display device DD may further include an optical layer RCL disposed between the display module DM and the window CW. The optical layer RCL may be disposed on the input-sensing part TP. The optical layer RCL may be a layer for reducing reflectance for external light incident from the outside. The optical layer RCL may be formed on the display module DM through a continuous process. The optical layer RCL may include a polarizing plate and/or may include a color filter layer. For example, the optical layer RCL may include at least one among a phase retarder, a polarizer, a polarizing film, and/or a polarizing filter. In some example embodiments, the optical layer RCL may include a plurality of color filters arranged in a regular arrangement and a black matrix adjacent to the color filters.

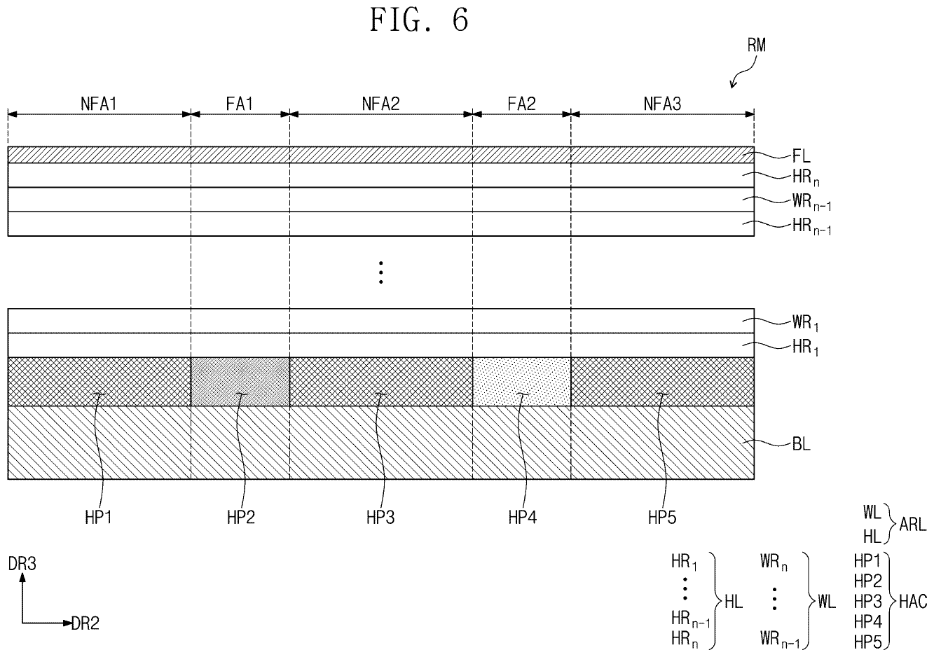

FIG. 6 is a cross-sectional view illustrating a protective member RM according to some example embodiments. FIG. 6 may be a cross-sectional view specifically illustrating a configuration of the protective member RM illustrated in FIG. 5.

Referring to FIG. 6, the protective member RM may include a protective base layer BL, a hard coating layer HAC, and/or an anti-reflection layer ARL. The protective member RM may further include a functional layer FL disposed on the anti-reflection layer ARL. A protective member, which includes a structure where a plurality of members are stacked so as to improve display quality, protect a lower member, and the like, is vulnerable to cracks when folding and unfolding are repeated. The lower member may be a component disposed under the protective member, and may include the display module DM (see FIG. 5), and the like. However, the protective member RM according to some example embodiments may exhibit a property that facilitates a repetition of folding and unfolding while maintaining a low reflection property by improving or optimizing a physical property of portions overlapping first and second folding regions FA1 and FA2. A display device DD including the protective member RM according to some example embodiments may exhibit excellent or improved display quality and excellent or improved folding reliability.

The hard coating layer HAC and/or the anti-reflection layer ARL may be disposed on the protective base layer BL. The protective base layer BL may be a member for providing a base surface where the hard coating layer HAC and the anti-reflection layer ARL are disposed. For example, the protective base layer BL may be a polymer film with flexibility. The protective base layer BL may include at least one among polyethylene terephthalate, polyimide, polyacrylate, polymethylmethacrylate, polycarbonate, polyethylenenaphthalate, polyvinylidene chloride, polyvinylidene difluoride, polystyrene, and/or ethylene vinylalcohol copolymer. A thickness of the protective base layer BL may be about 65 μm. However, this is an example, and the thickness of the protective base layer BL is not limited thereto.

The functional layer FL may include a polymer film with flexibility. The functional layer FL may include an anti-fingerprint coating agent, an antistatic agent, etc. Unlike what is illustrated, the functional layer FL may be omitted.

The anti-reflection layer ARL may be disposed on the hard coating layer HAC. The anti-reflection layer ARL may include a high refractive layer HL and/or a low refractive layer WL disposed on the high refractive layer HL. The anti-reflection layer ARL may be formed through a dry process. The high refractive layer HL may be provided as a plurality of high refractive layers HR₁, . . . , HRₙ₋₁, HRₙ. The low refractive layer WL may be provided as a plurality of low refractive layers WR₁, . . . , WRₙ₋₁. Here, n is a natural number greater than or equal to 3. The protective member RM including the plurality of high refractive layers HR₁, . . . , HRₙ₋₁, HRₙ and the plurality of low refractive layers WR₁, . . . , WRₙ₋₁ may exhibit low reflectance, thereby improving the display quality of the display device DD. The plurality of high refractive layers HR₁, . . . , HRₙ₋₁, HRₙ and the plurality of low refractive layers WR₁, . . . , WRₙ₋₁ may be alternately arranged. The functional layer FL may be disposed on an n-th high refractive layer HRₙ. For example, the high refractive layer HL may be provided in three layers, and the low refractive layer WL may be provided in two layers.

Unlike what is illustrated, the n-th high refractive layer HRₙ may be omitted. In this case, the functional layer FL may be disposed on an (n−1)-th low refractive layer WRₙ₋₁.

For example, a refractive index of the low refractive layer WL for light with a wavelength of about 550 nm may be about 1.3 to about 1.5. The refractive index of the low refractive layer WL for the light with the wavelength of about 550 nm may be about 1.46. A refractive index of the high refractive layer HL for light with a wavelength of about 550 nm may be about 1.6 to about 2.5. The refractive index of the high refractive layer HL for the light with the wavelength of about 550 nm may be about 2.17. In this specification, the refractive index may be measured by a critical angle method. The refractive index may be measured by a precision refractometer type KPR-30A.

According to a relative visibility curve, green color light corresponds to light that has a high impact on reflectance which degrades the display quality of the display device, and the wavelength of about 550 nm corresponds to the green color light. With a maximum visibility being 1, a ratio of visibility to light with a certain wavelength (about 380 nm to about 760 nm) is referred to as a relative visibility, and this is represented by a curve, which is the relative visibility curve. The anti-reflection layer ARL including the high refractive layer HL and the low refractive layer WL of which the refractive indexes for the light with the wavelength of about 550 nm satisfy the aforementioned ranges may contribute to improving the display quality of the display device DD (see FIG. 4).

The low refractive layer WL may contain SiO₂ and/or Si₉Al₂O₁₀. However, this is an example, and the low refractive layer WL may contain, without limitation, a material that is known in the art to have a property of a low refractive index.

The high refractive layer HL may include Ti₁₄Nb₃O₃₅ formed from niobium pentoxide (Nb₂O₅) and titanium dioxide (TiO₂). In the high refractive layer HL, based on a sum of a fifth weight of niobium pentoxide and a sixth weight of titanium dioxide, a ratio of the fifth weight to the sixth weight may be about 9:1. A member containing niobium pentoxide may have improved flexibility, and a member containing titanium dioxide may exhibit high hardness. The high refractive layer HL, which is formed from niobium pentoxide and titanium dioxide, and satisfies that a ratio of the fifth weight of niobium pentoxide to the sixth weight of titanium dioxide is about 9:1, may exhibit excellent or improved flexibility and excellent or improved hardness. Accordingly, the high refractive layer HL may exhibit a property that facilitates low curvature folding and a repetition of folding and unfolding. The display device DD (see FIG. 4) including the high refractive layer HL and the electronic apparatus EA (see FIG. 4) may exhibit excellent or improved reliability.

Specular component included (SCI) reflectance of the hard coating layer HAC according to some example embodiments may be about 1.0% or less. The SCI reflectance may be reflectance for the light with the wavelength of about 550 nm. The hard coating layer HAC, which has the SCI reflectance of about 1.0% or less, may have small reflectance, thereby improving the display quality of the display device DD (see FIG. 4).

In some example embodiments, the hard coating layer HAC may include first to fifth portions HP1, HP2, HP3, HP4, and/or HP5. The first to fifth portions HP1 to HP5 may have an integrated shape. The first to fifth portions HP1 to HP5 may be defined as portions respectively overlapping the first non-folding region NFA1, the first folding region FA1, the second non-folding region NFA2, the second folding region FA2, and/or the third non-folding region NFA3. Specifically, the first to fifth portions HP1 to HP5 may be defined as portions respectively overlapping the first non-folding portion NFP1-D, the first folding portion FP1-D, the second non-folding portion NFP2-D, the second folding portion FP2, and the third non-folding portion NFP3-D.

The second portion HP2 overlapping the first folding region FA1 may be out-folded in a first mode. The fourth portion HP4 overlapping the second folding region FA2 may be in-folded in the first mode. The second and fourth portions HP2 and HP4 may each be in-folded in a third mode.

The second portion HP2 and/or the fourth portion HP4 which are folded may each, or one or more, be formed to have a high elongation rate, and may thus exhibit a property that facilitates a repetition of folding and unfolding. The first portion HP1, the third portion HP3, and/or the fifth portion HP5 which are not folded may be formed to have high hardness, and may thus exhibit excellent or improved wear resistance and/or friction resistance. Accordingly, the protective member RM including the first to fifth portions HP1 to HP5 may exhibit excellent or improved reliability.

The hard coating layer HAC according to some example embodiments may include portions with different Young's modulus and/or hardness. The Young's modulus of the second portion HP2 may be smaller than the Young's modulus of the fourth portion HP4. The hardness of the second portion HP2 may be smaller than the hardness of the fourth portion HP4. The second portion HP2 capable of performing an out-folding operation may have smaller Young's modulus and hardness than the fourth portion HP4 incapable of performing the out-folding operation. More stress is applied to the members of the electronic apparatus EA (see FIG. 5) during the out-folding operation than an in-folding operation. In some example embodiments, the second portion HP2 may have relatively small Young's modulus and small hardness, thereby exhibiting greater flexibility and a property that facilitates the out-folding operation.

The Young's modulus of each, or one or more, of the second portion HP2 and/or the fourth portion HP4 may be about 3 GPa to about 6 GPa. The hardness of each, or one or more, of the second portion HP2 and/or the fourth portion HP4 may be about 0.3 GPa to about 0.5 GPa. For example, the Young's modulus of the second portion HP2 may be about 4.55 GPa, and/or the Young's modulus of the fourth portion HP4 may be about 3.52 GPa. The hardness of the second portion HP2 may be about 0.40 GPa, and/or the hardness of the fourth portion HP4 may be about 0.36 GPa.

The hardness and/or Young's modulus may be measured at an indentation depth of about 200 nm using a Bruker's nano-indenter by providing the hard coating layer HAC of about 5 μm in thickness onto the protective base layer BL containing polyethyleneterephthalate. The hard coating layer HAC of which the hardness and/or Young's modulus satisfy the aforementioned ranges may exhibit excellent or improved reliability.

In the hard coating layer HAC, Young's modulus and/or hardness of portions overlapping non-folding regions NFA1, NFA2, and/or NFA3 (that is, the first portion HP1, the third portion HP3, and/or the fifth portion HP5) may be greater than Young's modulus and/or hardness of portions overlapping the folding regions FA1 and/or FA2 (that is, the second portion HP2 and the fourth portion HP4). Young's modulus and/or hardness of the first portion HP1 overlapping a first non-folding region NFA1 may be greater than the Young's modulus and/or hardness of the fourth portion HP4 overlapping the second folding region FA2. Young's modulus and/or hardness of the third portion HP3 overlapping the second non-folding region NFA2 may be greater than the Young's modulus and/or hardness of the fourth portion HP4 overlapping the second folding region FA2. Young's modulus and/or hardness of the fifth portion HP5 overlapping the third non-folding region NFA3 may be greater than the Young's modulus and/or hardness of the fourth portion HP4 overlapping the second folding region FA2.

The first portion HP1, the third portion HP3, and/or the fifth portion HP5 may each, or one or more, have Young's modulus of about 6 GPa to about 8 GPa. The first portion HP1, the third portion HP3, and/or the fifth portion HP5 may each, or one or more, have substantially the same Young's modulus. In some example embodiments, at least one Young's modulus of each, or one or more, of the first portion HP1, the third portion HP3, and/or the fifth portion HP5 may be different. The first portion HP1, the third portion HP3, and/or the fifth portion HP5 may each, or one or more, have hardness of about 0.8 GPa to about 1.0 GPa. The first portion HP1, the third portion HP3, and/or the fifth portion HP5 may each, or one or more, have substantially the same hardness. In some example embodiments, at least one hardness of each, or one or more, of the first portion HP1, the third portion HP3, and/or the fifth portion HP5 may be different. For example, the Young's modulus of each, or one or more, of the first portion HP1, the third portion HP3, and/or the fifth portion HP5 may be about 7.59 GPa. For example, the hardness of each, or one or more, of the first portion HP1, the third portion HP3, and/or the fifth portion HP5 may be about 0.99 GPa. In this specification, the wording “substantially the same” includes a case where physical measurements are the same and a case where there is a difference within a margin of error in a process.

A crack strain of each, or one or more, of the second and/or fourth portions HP2 and/or HP4 may be about 10% or more. A crack strain of each, or one or more, of the first portion HP1, the third portion HP3, and/or the fifth portion HP5 may be about 7% or more. Since the hard coating layer HAC including the first to fifth portions HP1 to HP5 that satisfy a crack strain according to some example embodiments have excellent or improved flexibility, damage may be reduced or prevented during low curvature folding, and a property that facilitates a repetition of folding and unfolding may be exhibited.

The hard coating layer HAC according to some example embodiments may have a water contact angle of about 100° or more before an eraser anti-wear evaluation, and may have a water contact angle of about 95° or less after the evaluation. Here, the eraser anti-wear evaluation may be performed by 5000 reciprocating movements with a 1 Kgf load using an eraser exclusively for a wear resistance test. The hard coating layer HAC, of which the water contact angle satisfies the aforementioned ranges before and after the eraser anti-wear evaluation, may exhibit excellent or improved wear resistance.

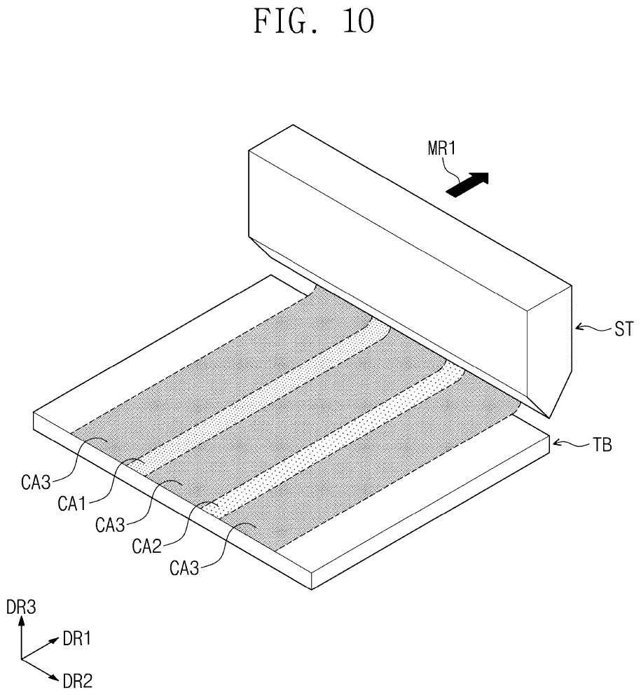

The second portion HP2 may be formed by providing a first coating composition CA1 (see FIG. 10), and the fourth portion HP4 may be formed by providing a second coating composition CA2 (see FIG. 10). A content of some materials of the second coating composition CA2 (see FIG. 10) may be different from that of the first coating composition CA1 (see FIG. 10). The second portion HP2 may contain a first polymer derived from the first coating composition CA1 (see FIG. 10), and the fourth portion HP4 may contain a second polymer derived from the second coating composition CA2 (see FIG. 10). The first polymer and the second polymer may be different.

The first and/or second coating compositions CA1 and CA2 (see FIG. 10) may each, or one or more, include a silsesquioxane-based resin, an oxetane-based resin, a cationic photopolymerization initiator, and/or a silica nanoparticle. In this specification, a “˜˜based” resin may be considered as including a functional group of “˜˜”.

The second and/or fourth portions HP2 and/or HP4 respectively overlapping the first and second folding regions FA1 and FA2 may be formed through a cationic photocuring reaction. In the cationic photocuring reaction, a hydrogen atom, which the oxetane-based resin includes, is dissociated, and a carbon atom at a dissociated position may be bonded to a silicon atom of the silsesquioxane-based resin. The first and second coating compositions CA1 and CA2 (see FIG. 10) may be cured through the cationic photocuring reaction, thereby exhibiting an excellent or improved coating property. A cationic photocuring process may reduce or minimize (or prevent) curing inhibition due to oxygen. For example, the first and/or second coating compositions CA1 and/or CA2 (see FIG. 10) according to some example embodiments may be cured through the cationic photocuring process, and may exhibit a low shrinkage rate during the curing and exhibit excellent or improved adhesion after the curing. The second and/or fourth portions HP2 and/or HP4 formed through the cationic photocuring reaction may exhibit a high elongation property.

The first coating composition CA1 (see FIG. 10) and the second coating composition CA2 (see FIG. 10) may be different in a weight of the silsesquioxane-based resin and a weight of the oxetane-based resin. In the first coating composition CA1 (see FIG. 10), a first weight of the silsesquioxane-based resin may be smaller than a second weight of the oxetane-based resin. In the second coating composition CA2 (see FIG. 10), a third weight of the silsesquioxane-based resin may be greater than a fourth weight of the oxetane-based resin. In the first coating composition CA1 (see FIG. 10), based on a sum of the first weight and the second weight, a ratio of the first weight to the second weight may be about 2:8 to about 4:6. In the second coating composition CA2 (see FIG. 10), based on a sum of the third weight and the fourth weight, a ratio of the third weight to the fourth weight may be about 6:4 to about 8:2. For example, the ratio of the first weight to the second weight may be about 4:6. The ratio of the third weight to the fourth weight may be about 6:4. A member formed by providing the oxetane-based resin may exhibit high flexibility as the content of the oxetane-base resin increases. Accordingly, the second portion HP2 formed from the first coating composition CA1 (see FIG. 10) which contains a relatively great weight of the oxetane-based resin may have high flexibility and exhibit a property that facilitates out-folding.

A second portion formed from a coating composition where a ratio of the first weight to the second weight is out of the range of about 2:8 to about 4:6 may not have enough flexibility, and a crack may occur during folding. A fourth portion formed from a coating composition where a ratio of the third weight to the fourth weight is out of the range of about 6:4 to about 8:2 may not have enough flexibility, and a crack may occur during folding.

On the basis of 100 wt % of a total weight of the first coating composition CA1 (see FIG. 10), a sum of the first weight and the second weight may be about 93 wt % to about 95 wt %. The second portion HP2 formed from the first coating composition CA1 (see FIG. 10) where the sum of the first weight and the second weight is about 93 wt % to about 95 wt % on the basis of 100 wt % of the total weight of the first coating composition CA1 (see FIG. 10) may exhibit excellent or improved flexibility, and a crack may be reduced or prevented during the low curvature folding.

On the basis of 100 wt % of a total weight of the second coating composition CA2 (see FIG. 10), a sum of the third weight and the fourth weight may be about 93 wt % to about 95 wt %. The fourth portion HP4 formed from the second coating composition CA2 (see FIG. 10) where the sum of the third weight and the fourth weight is about 93 wt % to about 95 wt % on the basis of 100 wt % of the total weight of the second coating composition CA2 (see FIG. 10) may exhibit excellent or improved flexibility, and a crack may be reduced or prevented during the low curvature folding.

In the first and/or second coating compositions CA1 and CA2, the silsesquioxane-based resin may include at least one among a partial cage structure, a ladder structure, a random structure, a T₈ cage structure, a T₁₀ cage structure, and/or a T₁₂ cage structure. The silsesquioxane-based resin may include a moiety represented by any one of the following Formulae S-1 to S-6.

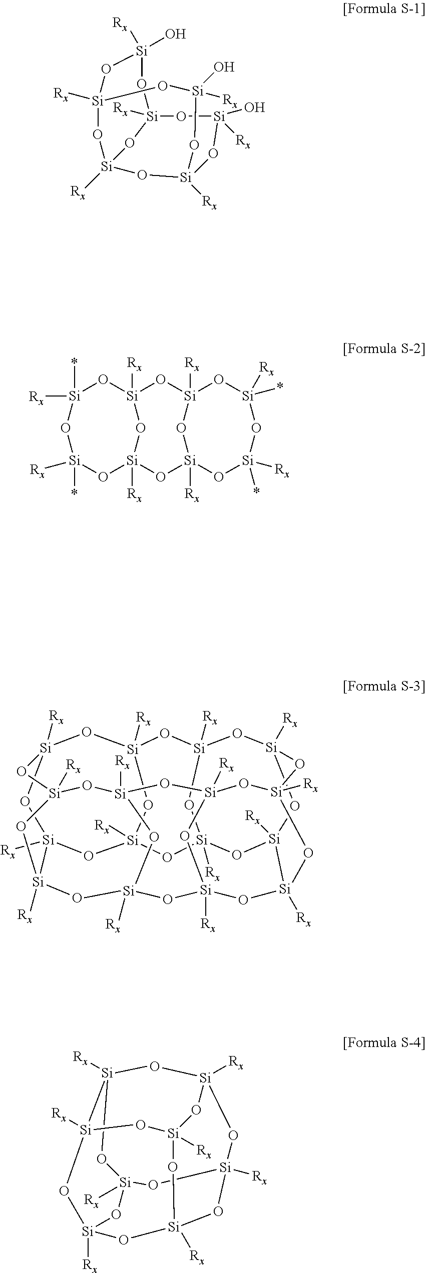

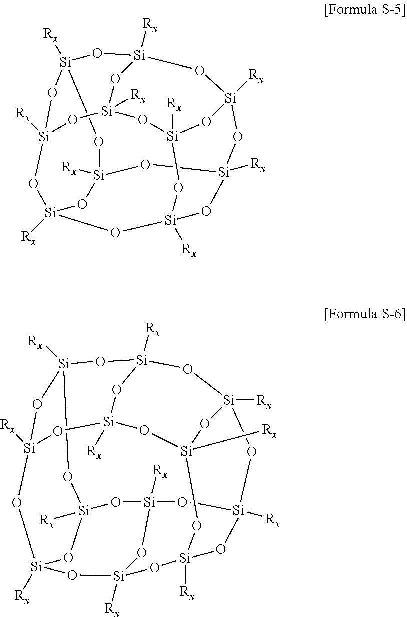

The moiety represented by the Formula S-1 includes the partial cage structure. The moiety represented by the Formula S-2 includes the ladder structure. The moiety represented by the Formula S-3 includes the random structure. The moiety represented by the Formula S-4 includes the Ts cage structure. The moiety represented by the Formula S-5 includes T₁₀ cage structure. The moiety represented by the Formula S-6 includes the T₁₂ cage structure. In the Formulae S-1 to S-6, each, or one or more, of a plurality of Rₓ may be independently a hydrogen atom, an alkyl group having 1 to 60 carbon atoms, an alkenyl group having 2 to 60 carbon atoms, an alkoxy group having 1 to 60 carbon atoms, or an aryl group having 6 to 60 ring-forming carbon atoms.

In the first and/or second coating compositions CA1 and CA2 (see FIG. 10), the oxetane-based resin may contain at least one among 1,4-bis[(3-ethyl-3-oxetanylmethoxy)methyl]benzene and 2-ethylhexyloxetane. 1,4-bis[(3-ethyl-3-oxetanylmethoxy)methyl]benzene may include a moiety represented by the following Formula O-1. 2-ethylhexyloxetane may include a moiety represented by the following Formula O-2.

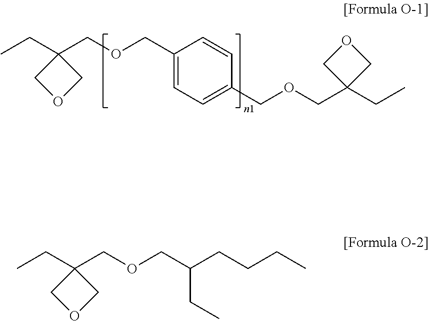

In the Formula O-1, n1 may be an integer between 3 and 100. For example, the n1 may be 3. As the n1 increases, a member formed from the oxetane-based resin including the moiety represented by the Formula O-1 may exhibit high flexibility.

On the basis of 100 wt % of the total weight of the first coating composition CA1 (see FIG. 10), a weight of the cationic photopolymerization initiator may be about 2 wt % or less. On the basis of 100 wt % of the total weight of the second coating composition CA2 (see FIG. 10), a weight of the cationic photopolymerization initiator may be about 2 wt % or less. In each, or one or more, of the first and/or second coating compositions CA1 and/or CA2 (see FIG. 10), the cationic photopolymerization initiator may contain triarylsulfonium hexafluoroantimonate salt. The first and/or second coating compositions CA1 and/or CA2 (see FIG. 10) containing the triarylsulfonium hexafluoroantimonate salt and/or reduced or minimize (or prevent) curing inhibition due to oxygen in the photocuring reaction.

Hexafluoroantimonate salt may be a mixed salt of a triarylsulfonium ion and a hexafluoroantimonate ion. The hexafluoroantimonate salt may be represented by the following Formula T-1. In the following Formula T-1, S⁺ of triarylsulfonium and/or Sb⁻ of hexafluoroantimonate may be ionically bonded.

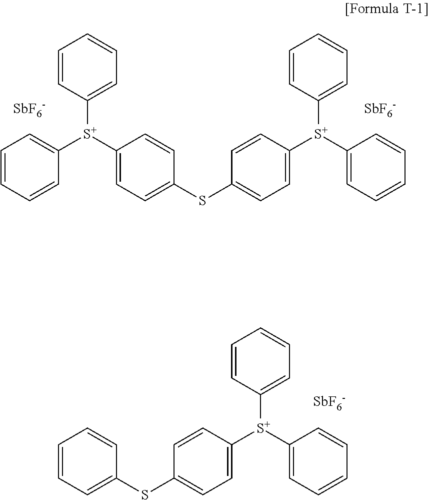

A diameter of the silica nanoparticle may be about 20 nm to about 60 nm. On the basis of 100 wt % of the total weight of the first coating composition CA1 (see FIG. 10), a weight of the silica nanoparticle may be about 3 wt % to about 5 wt %. On the basis of 100 wt % of the total weight of the second coating composition CA2 (see FIG. 10), a weight of the silica nanoparticle may be about 3 wt % to about 5 wt %. The hard coating layer HAC, which is formed from the first and/or second coating compositions CA1 and/or CA2 (see FIG. 10) containing the silica nanoparticle that satisfies the above-mentioned diameter range and weight range, may exhibit excellent or improved hardness and excellent or improved wear resistance.

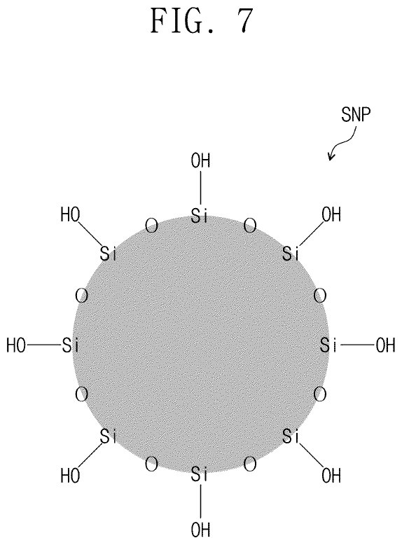

FIG. 7 illustrates an example of a silica nanoparticle SNP according to some example embodiments. Referring to FIG. 7, the silica nanoparticle SNP may contain a silicon atom, an oxygen atom, and/or a hydroxy group (—OH). In the silica nanoparticle SNP, the silicon atom (Si) and/or the oxygen atom (O) may be placed on a surface, and the hydroxy group may be bonded to the silicon atom on the surface. In FIG. 7, the number/location of the silicon atom, the number/location of the oxygen atom, and the number/location of the hydroxy group are illustrated, as an example, however example embodiments of the inventive concepts are not limited thereto.

In first to third coating compositions CA1, CA2, and/or CA3 (see FIG. 10) according to some example embodiments, the hydroxy group of the silica nanoparticle SNP may be partially bonded to a silsesquioxane-based resin. Accordingly, when curing the first to third coating compositions CA1, CA2, and/or CA3 (see FIG. 10), bonding force of the silica nanoparticle SNP with the silsesquioxane-based resin may be improved, and a hard coating layer HAC formed from the first to third coating compositions CA1, CA2, and CA3 (see FIG. 10) according to some example embodiments may exhibit excellent or improved wear resistance and/or excellent or improved friction resistance.

Referring to FIG. 6 again, the first portion HP1, the third portion HP3, and/or the fifth portion HP5 may be formed by providing the third coating composition CA3 (see FIG. 10). The first portion HP1, the third portion HP3, and/or the fifth portion HP5 may contain a third polymer derived from the third coating composition CA3 (see FIG. 10). The third polymer may be different from the first and/or second polymers.

The third coating composition CA3 (see FIG. 10) may include some materials different from the first and second coating compositions CA1 and CA2 (see FIG. 10). The third coating composition CA3 (see FIG. 10) may include a silsesquioxane-based resin, a polymer resin including a radical photopolymerization functional group, a radical photopolymerization initiator, and/or a silica nanoparticle. The third coating composition CA3 (see FIG. 10) may include the same silica nanoparticle as the silica nanoparticle included in the first and/or second coating compositions CA1 and/or CA2 (see FIG. 10). The third coating composition CA3 (see FIG. 10) may include the same silsesquioxane-based resin as the silsesquioxane-based resin included in the first and/or second coating compositions CA1 and/or CA2 (see FIG. 10). For instance, in the first to third coating compositions CA1, CA2, and/or CA3 (see FIG. 10), the silsesquioxane-based resin may include a partial cage structure. Accordingly, a refractive index of the first portion HP1, the third portion HP3, and/or the fifth portion HP5 may be substantially the same as a refractive index of the second and/or fourth portions HP2 and/or HP4. For example, a refractive index of the hard coating layer HAC including the first to fifth portions HP1 to HP5 may be about 1.50. casein some example embodiments, the refractive index of about 1.50 may be a refractive index for light in a 550 nm wavelength region.

In the first to third coating compositions CA1 to CA3 (see FIG. 10), the silsesquioxane-based resin may be a main component provided in large quantities. Since the first to third coating compositions CA1, CA2, and/or CA3 (see FIG. 10) contain the same silsesquioxane-based resin, the refractive indexes of the first to fifth portions HP1 to HP5, which are formed from any one of the first to third coating compositions CA1, CA2, and/or CA3 (see FIG. 10), may be substantially the same. Since the first to third coating compositions CA1, CA2, and/or CA3 (see FIG. 10) contain the same silsesquioxane-based resin, bonding force between the silsesquioxane-based resins of each, or one or more, of the first to third coating compositions CA1, CA2, and/or CA3 (see FIG. 10) may be increased. Accordingly, the hard coating layer HAC may be formed with the uniform refractive index and the uniform thickness, and thus the display device DD (see FIG. 4) may maintain excellent or improved display quality. In the hard coating layer HAC formed with the uniform thickness, a stepped portion may not exist at a boundary between adjacent portions of the first to fifth portions HP1 to HP5.

Unlike that the second and fourth portions HP2 and/or HP4 overlapping the first and second folding regions FA1 and FA2 are formed through a cationic photocuring reaction, the first portion HP1, the third portion HP3, and/or the fifth portion HP5 respectively overlapping the first to third non-folding regions NFA1, NFA2, and NFA3 may be formed through a radical photocuring reaction. In the radical photocuring reaction, a hydrogen atom contained in a polymer resin including a radical photopolymerization functional group may be dissociated, and a carbon atom at a dissociated position may be bonded to a silicon atom of the silsesquioxane-based resin. The first portion HP1, the third portion HP3, and/or the fifth portion HP5 formed through the radical photocuring reaction may exhibit a high hardness property, and satisfy the aforementioned Young's modulus range (that is, about 6 GPa to about 8 GPa) and hardness range (that is, about 0.8 GPa to about 1.0 GPa).

On the basis of 100 wt % of a total weight of the third coating composition CA3 (see FIG. 10), a sum of a weight of the silsesquioxane-based resin and a weight of the polymer resin including the radical photopolymerization functional group may be about 93 wt % to about 95 wt %. The radical photopolymerization functional group refers to a functional group in which a chemical reaction occurs during the radical photocuring reaction. The polymer resin including the radical photopolymerization functional group may contain at least one among pentaerythritol tetraacrylate, trimethylolpropane trimethacrylate, and/or ethylene oxide-modified isocyanurate diacrylate. For example, the polymer resin including the radical photopolymerization functional group may contain pentaerythritol tetraacrylate and/or trimethylolpropane trimethacrylate. On the basis of a sum of a seventh weight of pentaerythritol tetraacrylate and an eighth weight of trimethylolpropane trimethacrylate, a weight ratio of the seventh weight to the eighth weight may be about 3:7 to about 7:3. Specifically, on the basis of the sum of the seventh weight of pentaerythritol tetraacrylate and the eighth weight of trimethylolpropane trimethacrylate, the weight ratio of the seventh weight to the eighth weight may be about 5:5.

Pentaerythritol tetraacrylate may include a moiety represented by the following Formula D-1. Trimethylolpropane trimethacrylate may include a moiety represented by the following Formula D-2. Ethylene oxide-modified isocyanurate diacrylate may include a moiety represented by the following Formula D-3.

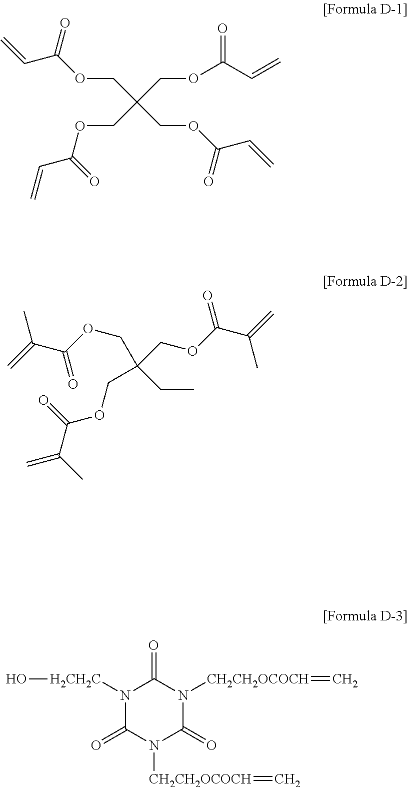

In the third coating composition CA3 (see FIG. 10), the radical photopolymerization initiator may include diphenyl(2,4,6-trimethylbenzoyl phosphine) oxide. Diphenyl(2,4,6-trimethylbenzoyl phosphine) oxide may be represented by the following Formula R-1.

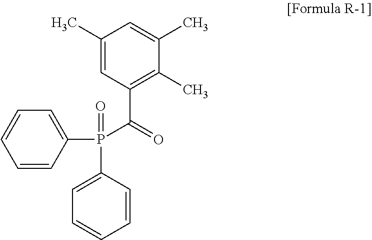 [SMILES: Cc1cc(C)c(C)c(C(=O)P(=O)(c2ccccc2)c2ccccc2)c1]

Each, or one or more, of the first to third coating compositions CA1, CA2, and/or CA3 (see FIG. 10) may further include a solvent. In each, or one or more, of the first to third coating compositions CA1, CA2, and/or CA3 (see FIG. 10), the solvent may include at least one among 1-methoxy-2-methyl-2-propanol and 2-butanone.

In some example embodiments, each, or one or more, of the first to third coating compositions CA1, CA2, and/or CA3 (see FIG. 10) may further include an additive within a range that does not impair a physical property of the hard coating layer HAC. The additive may include a leveling agent, a dispersant, etc. However, this is an example, and the additive may be included without limitation as long as the additive is known in the art. For example, on the basis of 100 wt % of the total weight of the first coating composition CA1 (see FIG. 10), a weight of the additive may be about 2 wt %. On the basis of 100 wt % of the total weight of the second coating composition CA2 (see FIG. 10), a weight of the additive may be about 2 wt %. On the basis of 100 wt % of the total weight of the third coating composition CA3 (see FIG. 10), a weight of the additive may be about 2 wt %.

The hard coating layer HAC formed from the first to third coating compositions CA1, CA2, and/or CA3 (see FIG. 10) including the silsesquioxane-based resin may exhibit a peak at wavenumbers of about 1066 cm⁻¹ and about 2138 cm⁻¹ on an infrared (IR) spectrum according to infrared spectroscopy. Exhibiting the peak at the wavenumber of about 1066 cm⁻¹ is considered as including a moiety of Si—O—Si, and exhibiting the peak at the wavenumber of about 2138 cm⁻¹ is considered as including a moiety of Si—H.

The hard coating layer HAC formed from the third coating composition CA3 (see FIG. 10) containing diphenyl(2,4,6-trimethylbenzoyl phosphine) oxide may exhibit a peak at wavenumbers of about 1650 cm⁻¹ to about 1800 cm⁻¹ (for example, about 1717 cm⁻¹) on an infrared (IR) spectrum according to infrared spectroscopy. Exhibiting the peak at the wavenumber of about 1650 cm⁻¹ to about 1800 cm⁻¹ is considered as including a carbonyl group.

Table 1 below shows components of a protective member in Comparative Examples and Experimental Examples used for evaluation of Table 2. Table 2 below shows a protective member in Comparative Examples and Experimental Examples by evaluating crack strain, wear resistance, and SCI reflectance.

TABLE 1

| | | | | Experimental |
|---|---|---|---|---|
| | | | Experimental | Example |
| | Compar- | Compar- | Example | Non- |
| | ative | ative | Folding | folding |
| | Example 1 | Example 2 | portion | portion |
| Protective base | PET, 50 um | PET, 50 um | PET, 65 um | |
| layer | | | | |
| Hard coating | Composition | Composition | Composition | Composition |
| layer | A-1 | A-1 | A-2 | A-3 |

| | | | |
|---|---|---|---|
| Anti-reflection | ZrOₓ/SiOₓ | Nb₂O₅/SiO₂ | Ti₁₄Nb₃O₃₅/Si₉Al₂O₁₀ |
| layer | (2 layers) | (7 layers) | (5 layers, |
| | | | Nb₂O5:TiO₂ = 9:1) |

In the protective member of Comparative Examples 1 and 2, a thickness of the protective base layer is about 50 μm, and in the protective member of Experimental Example, a thickness of the protective base layer is about 65 μm. In the protective member of Comparative Example 1, Comparative Example 2, and Experimental Example, the protective base layer contains polyethylene terephthalate (PET).

In the protective member of Comparative Examples 1 and 2, the hard coating layer is formed from the composition A-1, and the composition A-1 contains an acrylate-based resin and does not contain a silica nanoparticle. The acrylate-based resin exhibits a relatively low elongation rate.

The protective member of Experimental Example is formed by providing different compositions to the folding portion (that is, the aforementioned second and fourth portions HP2 and HP4) overlapping the folding region FA and the non-folding portion (that is, the aforementioned first, third, and fifth portions HP1, HP3, and HP5) overlapping the non-folding region NFA during formation of the hard coating layer. In the hard coating layer, the folding portion is formed from the composition A-2, and the non-folding portion is formed from the composition A-3. The composition A-2 includes the same materials as the aforementioned first and second coating compositions CA1 and CA2, and the composition A-2 contains a silsesquioxane-based resin, an oxetane-based resin, a cationic photopolymerization initiator, and/or a silica nanoparticle. In the composition A-2, a ratio of a weight of the silsesquioxane-based resin to a weight of the oxetane-based resin is about 5:5.

The composition A-3 is the same as the aforementioned third coating composition CA3. The composition A-3 contains a silsesquioxane-based resin, a polymer resin including a radical photopolymerization functional group, a radical photopolymerization initiator, and/or a silica nanoparticle. In the composition A-3, each, or one or more, of the silsesquioxane-based resin, the polymer resin including a radical photopolymerization functional group, the radical photopolymerization initiator, and/or the silica nanoparticle satisfies the aforementioned weight range.

The protective member of Comparative Example 1, Comparative Example 2, and Experimental Example includes a high refractive layer and a low refractive layer which are alternately arranged. In the protective member of Comparative Example 1, the anti-reflection layer includes the two layers formed through a wet process, including one high refractive layer and one low refractive layer disposed on the one high refractive layer. In the protective member of Comparative Example 1, the high refractive layer contains zirconium oxide (ZrOₓ), and the low refractive layer contains silicon oxide (SiOₓ).

In the protective member of Comparative Example 2, the anti-reflection layer includes seven layers formed through a dry process, including three high refractive layers and four low refractive layers. A low refractive layer is disposed on the protective base layer, and on the low refractive layer, three high refractive layers and three low refractive layers are alternately arranged. In the protective member of Comparative Example 2, the high refractive layer contains niobium pentoxide (Nb₂O₅), and the low refractive layer contains silicon dioxide (SiO₂).

In the protective member of Experimental Example, the anti-reflection layer includes five layers formed through a dry process, including three high refractive layers and two low refractive layers. A high refractive layer is disposed on the protective base layer, and on the high refractive layer, two low refractive layers and two high refractive layers are alternately arranged. In the protective member of Experimental Example, the high refractive layer contains Ti₁₄Nb₃O₃₅, and the low refractive layer contains Si₉Al₂O₁₀. Ti₁₄Nb₃O₃₅ contained in the high refractive layer is formed by providing the weight of niobium pentoxide and titanium dioxide in a weight ratio of about 9:1.

In Table 2 below, the crack strain, wear resistance, and/or SCI reflectance are evaluated by a following method. In the crack strain, using an Instron's universal testing machine (UTM), the protective member of about 10 mm wide×about 60 mm long is fixed, and stretched at a speed of about 50 mm/min, and then cracks are checked. When the crack strain is about 10% or more in the folding portion, it is determined that reliability is satisfied. When the crack strain is about 7% or more in the non-folding portion, it is determined that reliability is satisfied.

The wear resistance evaluation is to evaluate whether a certain criterion is satisfied by comparing water contact angles before and after the eraser anti-wear evaluation. The certain criterion is that the water contact angle before the evaluation is about 100° or more, and the water contact angle after the evaluation is about 95° or more. When evaluating the water contact angle, the liquid provided is water. The eraser anti-wear evaluation is conducted by preparing a Munbangsau's industrial eraser with a protrusion of about 5 mm and using a Daesung Precision's wear resistance tester under conditions of a load of about 1 Kgf, a speed of about 50 rpm, and a round trip distance of about 15 mm. Then, a contact angle is measured by using a Kruss's drop shape analysis system.

‘NG’ in Table 2 means that the certain criterion is not satisfied in the wear resistance, and ‘OK’ means that the certain criterion is satisfied. Comparative Examples 1 and 2 are not evaluated since flexibility is very little and the wear resistance evaluation is not possible.

The SCI reflectance represents SCI reflectance for light with a wavelength of about 550 nm. The SCI reflectance is measured in a reflection mode of a Konica Minolta's spectrophotometer CM-3700A, and evaluated by attaching a black tape to one surface of PET of the protective member. When the SCI reflectance is about 1.0% or less, it is determined that a display quality criterion is satisfied. In the protective member of Experimental Example, the folding portion exhibits the SCI reflectance of about 0.56% to about 0.69%, and the non-folding portion exhibits the SCI reflectance of about 0.61% to about 0.7%.

TABLE 2

| | | | | Experimental |
|---|---|---|---|---|
| | | | Experimental | Example |
| | Compar- | Compar- | Example | Non- |
| | ative | ative | Folding | folding |
| | Example 1 | Example 2 | portion | portion |
| Crack Strain (%) | 4.5 | 2 | 12.5 | 7.5 |
| Wear resistance | — | — | OK | OK |
| SCI reflectance | 1.33 | 0.25 | 0.56~0.69 | 0.61~0.7 |
| (@550 nm, %) | | | | |

Referring to Table 2, in the protective member of Experimental Example, it may be seen that the folding portion has the crack strain of about 12.5%, which is about 10% or more. In the protective member of Experimental Example, it may be seen that the non-folding portion has the crack strain of about 7.5%, which is about 7% or more. It may be seen that the protective member of Experimental Example includes the protective base layer that is thicker than those of Comparative Examples 1 and 2, but exhibits excellent or improved crack strain. For example, it may be seen that the protective member of Experimental Example has the wear resistance that satisfies the certain criterion, and has the SCI reflectance of about 1.0% or less. As mentioned above, the protective member of Experimental Example includes the hard coating layer formed from the compositions A-2 and A-3, and the compositions A-2 and A-3 are coating compositions according to some example embodiments. Accordingly, it may be seen that the protective member including the hard coating layer formed from the coating compositions according to some example embodiments would exhibit excellent or improved reliability.

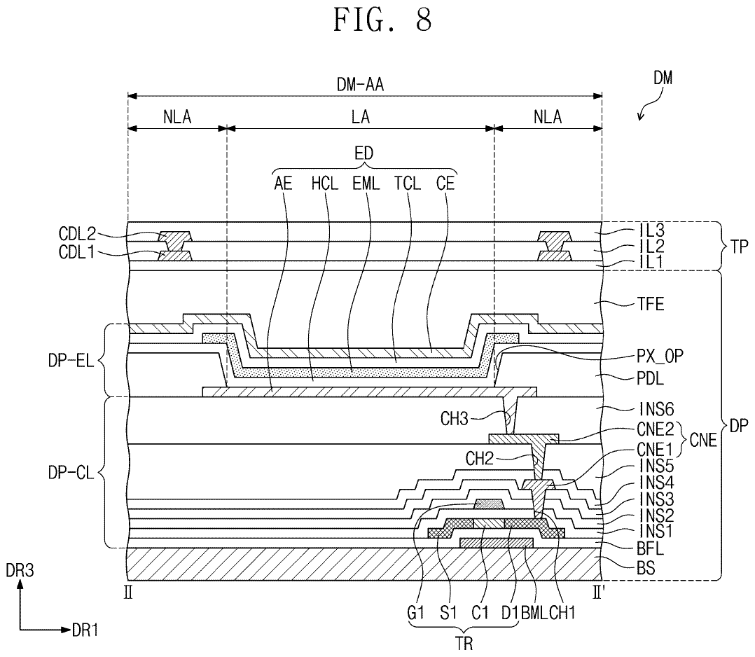

FIG. 8 is a cross-sectional view taken along line II-II′ of FIG. 4. FIG. 8 may be a cross-sectional view specifically illustrating an active region DM-AA of a display module DM.

Referring to FIG. 8, a display panel DP may include a base substrate BS, a circuit layer DP-CL disposed on the base substrate BS, a display element layer DP-EL disposed on the circuit layer DP-CL, and/or an encapsulation layer TFE covering the display element layer DP-EL. A configuration of the display panel DP illustrated in FIG. 8 is an example, and the configuration of the display panel DP is not limited thereto.

The base substrate BS may provide a base surface where the circuit layer DP-CL is disposed. The base substrate BS may be a flexible substrate which is bendable, foldable, rollable, etc. The base substrate BS may be a glass substrate, a metal substrate, a polymer substrate, and/or the like. However, some example embodiments of the inventive concepts are not limited thereto, and the base substrate BS may include an inorganic layer, an organic layer, and/or a composite material layer.

The base substrate BS may include a single layer or multiple layers. For example, the base substrate BS may include a first synthetic resin layer, a single- or multi-layered inorganic layer, and/or a second synthetic resin layer disposed on the single- or multi-layered inorganic layer. The first synthetic resin layer and/or the second synthetic resin layer may each, or one or more, include a polyimide-based resin. In addition, the first synthetic resin layer and the second synthetic resin layer may each include at least one among an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, and/or a perylene-based resin.

The display panel DP may include a transistor TR and/or a light-emitting element ED. The transistor TR and/or the light-emitting element ED may be disposed on the base substrate BS. One transistor TR is illustrated in FIG. 8, but the display panel DP may substantially include a plurality of transistors and at least one capacitor for driving the light-emitting element ED.

The circuit layer DP-CL may include an insulation layer, a semiconductor pattern, a conductive pattern, a signal line, and/or the like. For example, the circuit layer DP-CL may include a switching transistor and a driving transistor for driving the light-emitting element ED of the display element layer DP-EL.

The circuit layer DP-CL may include a shielding electrode BML, the transistor TR, a connection electrode CNE, and/or a plurality of insulation layers BFL and INS1 to INS6. The plurality of insulation layers BFL and INS1 to INS6 may include a buffer layer BFL and/or first to sixth insulation layers INS1 to INS6. However, a stacked structure of the circuit layer DP-CL illustrated in FIG. 8 is an example, and the stacked structure of the circuit layer DP-CL may be changed depending on the configuration of the display panel DP and a process of the circuit layer DP-CL, and/or the like.

The shielding electrode BML may be disposed on the base substrate BS. The shielding electrode BML may overlap the transistor TR. The shielding electrode BML may protect the transistor TR by blocking light incident from a lower part of the display panel DP to the transistor TR. The shielding electrode BML may include a conductive material. When a voltage is applied to the shielding electrode BML, a threshold voltage of the transistor TR disposed on the shielding electrode BML may be maintained. However, some example embodiments of the inventive concepts are not limited thereto, and the shielding electrode BML may be a floating electrode. The shielding electrode BML may be omitted.

The buffer layer BFL may be disposed on the base substrate BS to cover the shielding electrode BML. The buffer layer BFL may include an inorganic layer. The buffer layer BFL may improve bonding force between the base substrate BS and the conductive pattern and/or the semiconductor pattern disposed on the buffer layer BFL.

The transistor TR may include a source S1, a channel C1, a drain D1, and/or a gate G1. The source S1, the channel C1, and/or the drain D1 of the transistor TR may be formed from the semiconductor pattern. The semiconductor pattern of the transistor TR may include polysilicon, amorphous silicon, and/or metal oxide, and may be applied without limitation as long as having semiconductor properties, and is not limited to any one embodiment.

The semiconductor pattern may include a plurality of regions which are distinguished according to magnitude of conductivity. A region, of the semiconductor pattern, which is doped with a dopant or where a metal oxide is reduced may have high conductivity, and may substantially serve as a source electrode and drain electrode of the transistor TR. The region of the semiconductor pattern with high conductivity may correspond to the source S1 and/or drain D1 of the transistor TR. A region, of the semiconductor pattern, which is undoped or lightly doped, or where a metal oxide is non-reduced may have low conductivity, and thus correspond to the channel C1 (or active) of the transistor TR.

The first insulation layer INS1 may be disposed on the buffer layer BFL while covering the semiconductor pattern of the transistor TR. The gate G1 of the transistor TR may be disposed on the first insulation layer INS1. On a plane, the gate G1 may overlap the channel C1 of the transistor TR. The gate G1 may function as a mask in a process of doping the semiconductor pattern of the transistor TR.

The second insulation layer INS2 may be disposed on the first insulation layer INS1 while covering the gate G1. The third insulation layer INS3 may be disposed on the second insulation layer INS2.

The connection electrode CNE may include a first connection electrode CNE1 and/or a second connection electrode CNE2 for electrically connecting the transistor TR and the light-emitting element ED. However, a configuration of the connection electrode CNE for electrically connecting the transistor TR and the light-emitting element ED is not limited thereto, and one of the first and second connection electrodes CNE1 and CNE2 may be omitted, and/or an additional connection electrode may further be included.

The first connection electrode CNE1 may be disposed on the third insulation layer INS3. The first connection electrode CNE1 may be connected to the drain D1 through a first contact hole CH1 that penetrates the first to third insulation layers INS1 to INS3. The fourth insulation layer INS4 may be disposed on the third insulation layer INS3 while covering the first connection electrode CNE1. The fifth insulation layer INS5 may be disposed on the fourth insulation layer INS4.

The second connection electrode CNE2 may be disposed on the fifth insulation layer INS5. The second connection electrode CNE2 may be connected to the first connection electrode CNE1 through a second contact hole CH2 that penetrates the fourth and/or fifth insulation layers INS4 and/or INS5. The sixth insulation layer INS6 may be disposed on the fifth insulation layer INS5 while covering the second connection electrode CNE2.

The first to sixth insulation layers INS1 to INS6 may each, or one or more, include an inorganic layer or an organic layer. For example, the inorganic layer may include at least one of aluminum oxide, titanium oxide, silicon oxide, silicon oxynitride, zirconium oxide, and/or hafnium oxide. The organic layer may include at least one of an acrylate-based resin, a methacrylate-based resin, a polyisoprene-based resin, a vinyl-based resin, an epoxy-based resin, a urethane-based resin, a cellulose-based resin, a siloxane-based resin, a polyamide-based resin, and/or a perylene-based resin.

The display element layer DP-EL may include a pixel-defining film PDL and/or the light-emitting element ED. The light-emitting element ED may include a first electrode AE, a hole control layer HCL, a light-emitting layer EML, an electron control layer TCL, and/or a second electrode CE.

The light-emitting element ED may emit light. For example, the light-emitting element ED may include an organic light-emitting material, an inorganic light-emitting material, an organic-inorganic light-emitting material, quantum dots, and/or quantum rods. For example, the light-emitting element ED may include a micro LED and/or a nano LED.

The first electrode AE may be disposed on the sixth insulation layer INS6. The first electrode AE may be connected to the second connection electrode CNE2 through a third contact hole CH3 that penetrates the sixth insulation layer INS6. The first electrode AE may be electrically connected to the drain D1 of the transistor TR through the first and second connection electrodes CNE1 and/or CNE2.

The first electrode AE may be formed of a metallic material, a metal alloy, and/or a conductive compound. The first electrode AE may be an anode or a cathode. However, an embodiment of the inventive concept is not limited thereto. In addition, the first electrode AE may be a pixel electrode. The first electrode AE may be a transmissive electrode, a semi-transmissive electrode, and/or a reflective electrode. The first electrode AE may include at least one selected from Ag, Mg, Cu, Al, Pt, Pd, Au, Ni, Nd, Ir, Cr, Li, Ca, LiF, Mo, Ti, W, In, Sn, and/or Zn, a compound of two or more selected therefrom, a mixture of two or more selected therefrom, and/or an oxide thereof.

When the first electrode AE is the transmissive electrode, the first electrode AE may include transparent metal oxide, for example, indium tin oxide (ITO), indium zinc oxide (IZO), zinc oxide (ZnO), indium tin zinc oxide (ITZO), etc. When the first electrode AE is the semi-transmissive electrode and/or reflective electrode, the first electrode AE may include Ag, Mg, Cu, Al, Pt, Pd, Au, Ni, Nd, Ir, Cr, Li, Ca, LiF/Ca (a stacked structure of LiF and Ca), LiF/Al (a stacked structure of LiF and Al), Mo, Ti, W, and/or a compound and/or mixture thereof (for example, a mixture of Ag and Mg). In some example embodiments, the first electrode AE may have a multi-layered structure including a reflective film and/or semi-transmissive film formed from the above materials, and/or a transparent conductive film formed from indium tin oxide (ITO), indium zinc oxide (IZO), zinc oxide (ZnO), indium tin zinc oxide (ITZO), etc. For instance, the first electrode AE may have a three-layer structure of ITO/Ag/ITO, but is not limited thereto. For example, some example embodiments of the inventive concepts are not limited thereto, and the first electrode AE may include the aforementioned metal material, a combination of two or more metal materials selected from the aforementioned metal materials, an oxide of the aforementioned metal materials, and/or the like.

The pixel-defining film PDL may be disposed on the sixth insulation layer INS6. An emissive opening PX_OP exposing a portion of the first electrode AE may be defined in the pixel-defining film PDL. The portion of the first electrode AE exposed by the emissive opening PX_OP may be defined as a light-emitting region LA.

The active region DM-AA of the display module DM may include the light-emitting region LA and/or a light-shielding region NLA. A region where the pixel-defining film PDL is disposed may correspond to the light-shielding region NLA. The light-shielding region NLA may surround the light-emitting region LA within the active region DM-AA.

The hole control layer HCL may be disposed on the first electrode AE and/or the pixel-defining film PDL. The hole control layer HCL may be provided as a common layer overlapping the light-emitting region LA and/or the light-shielding region NLA. The hole control layer HCL may include at least one among a hole transport layer, a hole injection layer, and/or an electron blocking layer. The hole control layer HCL may include a known hole injection material and/or a known hole transport material.

The light-emitting layer EML may be disposed on the hole control layer HCL. The light-emitting layer EML may be disposed in a region corresponding to the emissive opening PX_OP. In some example embodiments, the light-emitting layer EML may be provided as a common layer. The light-emitting layer EML may include an organic light-emitting material and/or an inorganic light-emitting material. The light-emitting layer EML may emit color light of any one among red, green, and blue. For example, the light-emitting layer EML may emit blue color light.

The electron control layer TCL may be disposed on the light-emitting layer EML. The electron control layer TCL may be provided as a common layer overlapping the light-emitting region LA and/or the light-shielding region NLA. The electron control layer TCL may include at least one among an electron transport layer, an electron injection layer, and/or a hole blocking layer. The electron control layer TCL may include a known electron injection material and/or a known electron transport material.

The second electrode CE may be disposed on the electron control layer TCL. The second electrode CE may be provided as a common layer overlapping the light-emitting region LA and the light-shielding region NLA.

The second electrode CE may be a common electrode. The second electrode CE may be a cathode or an anode, but some example embodiments of the inventive concepts are not limited thereto. For example, when the first electrode AE is an anode, the second electrode CE may be a cathode, and when the first electrode AE is a cathode, the second electrode CE may be an anode.

The second electrode CE may be a transmissive electrode, a semi-transmissive electrode, and/or a reflective electrode. When the second electrode CE is the transmissive electrode, the second electrode CE may be composed of transparent metal oxide, for example, indium tin oxide (ITO), indium zinc oxide (IZO), zinc oxide (ZnO), indium tin zinc oxide (ITZO), etc.

When the second electrode CE is the semi-transmissive electrode or the reflective electrode, the second electrode CE may include Ag, Mg, Cu, Al, Pt, Pd, Au, Ni, Nd, Ir, Cr, Li, Ca, LiF/Ca, LiF/Al, Mo, Ti, Yb, W or a compound or mixture containing the above materials (for example, AgMg, AgYb, or MgYb). In some example embodiments, the second electrode CE may have a multi-layered structure including a reflective film and/or semi-transmissive film formed from the above materials, and/or a transparent conductive film formed from indium tin oxide (ITO), indium zinc oxide (IZO), zinc oxide (ZnO), indium tin zinc oxide (ITZO), etc. For instance, the second electrode CE may include the aforementioned metal material, a combination of two or more metal materials selected from the aforementioned metal materials, an oxide of the aforementioned metal materials, and/or the like.

The encapsulation layer TFE may be disposed on the display element layer DP-EL. The encapsulation layer TFE may be disposed on the second electrode CE to cover the light-emitting element ED. The encapsulation layer TFE may protect the display element layer DP-EL from moisture, oxygen, and/or foreign matters such as dust particles. The encapsulation layer TFE may include a plurality of thin films.

The encapsulation layer TFE may include at least one inorganic film. For example, the encapsulation layer TFE may include inorganic films disposed on the second electrode CE and/or an organic film disposed between the inorganic films. The inorganic film may protect the light-emitting element ED from moisture/oxygen, and the organic film may protect the light-emitting element ED from foreign matters such as dust particles.

An input-sensing part TP may be disposed on the display panel DP. For example, the input-sensing part TP may be directly disposed on the encapsulation layer TFE of the display panel DP. In some example embodiments, an adhesive layer may be disposed between the input-sensing part TP and the display panel DP.

In this specification, it will be understood that when one component is directly disposed/provided on/to another component, a third component is not disposed/provided between the one component and the other component. That is, the wording, one component being “directly disposed/provided” on/to another component means that the one component is “in direct contact” with the other component.

The input-sensing part TP may include a first sensing insulating layer IL1, a second sensing insulating layer IL2, and/or a third sensing insulating layer IL3. The input-sensing part TP may include at least one conductive layer disposed on the sensing insulating layers. The input-sensing part TP may include a first conductive layer CDL1 and/or a second conductive layer CDL2.

The first sensing insulating layer IL1 may be disposed on the encapsulation layer TFE. The first sensing insulating layer IL1 may include at least one inorganic insulating layer. The first sensing insulating layer IL1 may be in contact with the encapsulation layer TFE. In some example embodiments, the first sensing insulating layer IL1 may be omitted, and in this case, the first conductive layer CDL1 may be in contact with the encapsulation layer TFE.

The first conductive layer CDL1 may be disposed on the first sensing insulating layer IL1. The first conductive layer CDL1 may include a plurality of first conductive patterns. The plurality of first conductive patterns may be disposed on the first sensing insulating layer IL1. The second sensing insulating layer IL2 may be disposed on the first sensing insulating layer IL1 so as to cover at least a portion of the first conductive layer CDL1.

The second conductive layer CDL2 may be disposed on the second sensing insulating layer IL2. The second conductive layer CDL2 may include a plurality of second conductive patterns. The plurality of second conductive patterns may be disposed on the second sensing insulating layer IL2. The plurality of second conductive patterns may be respectively connected to the plurality of first conductive patterns through a contact hole which is formed in the second sensing insulating layer IL2.

The plurality of first conductive patterns of the first conductive layer CDL1 and/or the plurality of second conductive patterns of the second conductive layer CDL2 may each, or one or more be disposed corresponding to the light-shielding region NLA. The plurality of first conductive patterns of the first conductive layer CDL1 and the plurality of second conductive patterns of the second conductive layer CDL2 may each be a mesh pattern.

The third sensing insulating layer IL3 may be disposed on the second sensing insulating layer IL2, and may cover the second conductive layer CDL2. The second sensing insulating layer IL2 and/or the third sensing insulating layer IL3 may each, or one or more, include an inorganic insulating layer and/or an organic insulating layer.

The first conductive layer CDL1 and/or the second conductive layer CDL2 may each, or one or more, have a single-layered structure, or have a multi-layered structure stacked along a third direction DR3. The conductive layers CDL1 and/or CDL2 of the single-layered structure may include a metal layer and/or a transparent conductive layer. The metal layer may contain molybdenum, silver, titanium, copper, aluminum, and/or an alloy thereof. The transparent conductive layer may include transparent conductive oxide such as indium tin oxide (ITO), indium zinc oxide (IZO), zinc oxide (ZnO), and/or indium tin zinc oxide (ITZO). For example, the transparent conductive layer may include a conductive polymer such as PEDOT, metal nanowires, graphene, etc.

The conductive layers CDL1 and/or CDL2 of the multi-layered structure may include metal layers. The metal layers may have a three-layer structure of, for example, titanium (Ti)/aluminum (Al)/titanium (Ti). The conductive layers CDL1 and/or CDL2 of the multi-layered structure may include at least one metal layer and/or at least one transparent conductive layer.

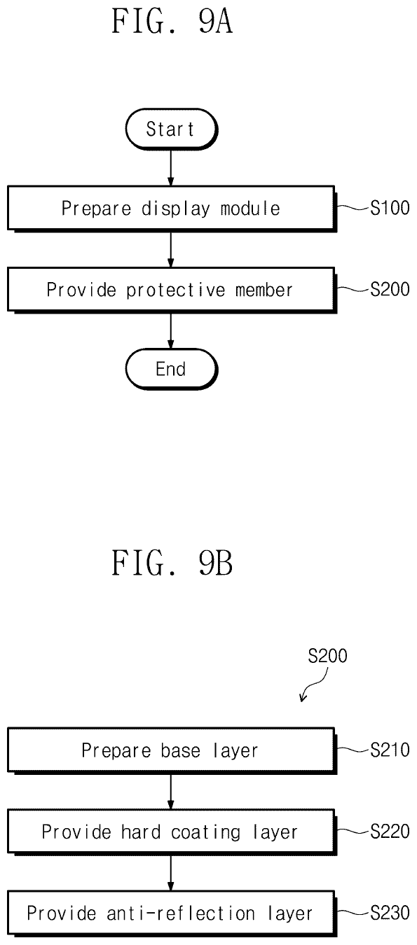

A display device according to some example embodiments may be manufactured through a method for manufacturing a display device according to some example embodiments. FIG. 9A and FIG. 9B are flowcharts illustrating a method for manufacturing a display device according to some example embodiments. FIG. 10 schematically illustrates a manufacturing step of a display device according to an embodiment. Hereinafter, in description to be made with reference to FIGS. 9A to 10, a duplicate content of the content previously described with reference to FIGS. 1 to 8 will not be described again, and differences will be mainly explained.

Referring to FIG. 9A, a method for manufacturing a display device according to some example embodiments may include a step S100 of preparing a display module and/or a step S200 of providing a protective member on the display module. Referring to FIG. 9B, the step S200 of providing the protective member on the display module may include a step S210 of preparing a protective base layer, a step S220 of providing a hard coating layer on the protective base layer, and/or a step S230 of providing an anti-reflection layer on the hard coating layer.

FIG. 10 illustrates a step of forming the hard coating layer HAC (see FIG. 6). First to third coating compositions CA1, CA2, and/or CA3 may be provided by a slit coating method. The first to third coating compositions CA1, CA2, and/or CA3 may have viscosity suitable to be provided by the slit coating method. The first to third coating compositions CA1, CA2, and/or CA3 may be provided to have the target viscosity by adjusting a weight of a silsesquioxane-based resin.

The first to third coating compositions CA1, CA2, and/or CA3 may be provided onto a carrier substrate TB from a slit coating machine ST. The carrier substrate TB may be a temporary substrate used for forming the hard coating layer HAC (see FIG. 6), and is not limited to any one embodiment as long as the substrate facilitates the formation of the hard coating layer HAC (see FIG. 6). In some example embodiments, the first to third coating compositions CA1, CA2, and/or CA3 may be directly provided onto the protective base layer BL (see FIG. 6). The slit coating machine ST may move from one side to the other side of the carrier substrate TB, in a movement direction MR1 that is parallel to a first direction DR1.

Light may be provided to the first to third coating compositions CA1, CA2, and/or CA3 provided onto the carrier substrate TB, and the provided first to third coating compositions CA1, CA2, and/or CA3 may be cured, and thus the hard coating layer HAC (see FIG. 6) according to some example embodiments may be formed. For example, ultraviolet light may be provided to the first to third coating compositions CA1, CA2, and/or CA3. However, this is an example, and a type of the light provided is not limited to any one embodiment as long as the light facilitates curing of the first to third coating compositions CA1, CA2, and/or CA3.

The first to third coating compositions CA1, CA2, and/or CA3 may be provided in the same step. Accordingly, the hard coating layer HAC (see FIG. 6) formed from the first to third coating compositions CA1, CA2, and/or CA3 may be formed to have a uniform thickness without a stepped portion. A stepped portion may not be formed at a boundary of adjacent portions among first to fifth portions HP1 to HP5 which are formed from the first to third coating compositions CA1, CA2, and/or CA3. For example, the hard coating layer HAC (see FIG. 6) formed from the first to third coating compositions CA1, CA2, and/or CA3 may be formed to have a uniform refractive index. Therefore, the method for manufacturing the display device according to some example embodiments may exhibit excellent or improved processability.

An electronic apparatus according to some example embodiments may include a display device of which at least a portion is accommodated in a housing. The display device according to some example embodiments may include a display module and/or a protective member, and in the display module, first to third non-folding portions and/or first and second folding portions between the first to third non-folding portions may be defined. The protective member may include a hard coating layer and/or an anti-reflection layer, and the hard coating layer may include first to fifth portions. The first, third, and/or fifth portions may respectively overlap the first to third non-folding portions, and the second and/or fourth portions may respectively overlap the first and second folding portions. Young's modulus and hardness of the second portion overlapping the first folding portion may be smaller than Young's modulus and hardness of the fourth portion overlapping the second folding portion. Accordingly, the second portion according to some example embodiments may exhibit a property that facilitates out-folding, and the hard coating layer including the second portion and the protective member including the same may exhibit a property that facilitates a repetition of folding and unfolding while exhibiting low reflectance. In some example embodiments, the display device including the protective member and/or the electronic apparatus including the same may exhibit excellent or improved display quality and excellent or improved folding reliability.

A display device according to some example embodiments and an electronic apparatus including the same may include a hard coating layer that satisfies Young's modulus and hardness according to some example embodiments, thereby exhibiting excellent or improved reliability.

A method for manufacturing a display device according to some example embodiments may provide a coating composition in the same step during formation of the hard coating layer, thereby exhibiting excellent or improved processability.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In the above, description has been made with reference to some example embodiments of the inventive concepts, but those skilled or of ordinary skill in the art may understand that various modifications and changes may be made to the inventive concepts insofar as such modifications and changes do not depart from the spirit and technical scope of the inventive concepts set forth in the claims to be described later.

Therefore, the technical scope of the inventive concepts are not to be limited to the contents stated in the detailed description of the specification, but should be determined by the claims.

What is claimed is:

1. A display device comprising:
a display module including a first non-folding portion, a first folding portion, a second non-folding portion, a second folding portion, and a third non-folding portion in order along one direction; and
a protective member on the display module, the protective member including
a protective base layer;
a hard coating layer on the protective base layer, the hard coating layer including a first portion overlapping the first non-folding portion, a second portion overlapping the first folding portion, a third portion overlapping the second non-folding portion, a fourth portion overlapping the second folding portion, and a fifth portion overlapping the third non-folding portion; and
an anti-reflection layer on the hard coating layer, the anti-reflection layer including a high refractive layer and a low refractive layer on the high refractive layer,
wherein the second portion includes a first polymer derived from a first coating composition,
wherein the fourth portion includes a second polymer derived from a second coating composition,
wherein each of the first coating composition and the second coating composition includes a silsesquioxane-based resin, an oxetane-based resin, a cationic photopolymerization initiator, and a silica nanoparticle, and
wherein a Young's modulus of the second portion and a hardness of the second portion are respectively smaller than a Young's modulus of the fourth portion and a hardness of the fourth portion.

2. The display device of claim 1, wherein each of the Young's modulus of the second portion and the Young's modulus of the fourth portion is 3 GPa to 6 GPa, and
each of the hardness of the second portion and the hardness of the fourth portion is 0.3 GPa to 0.5 GPa.

3. The display device of claim 1, wherein
each of a Young's modulus of the first portion, a Young's modulus of the third portion, and a Young's modulus of the fifth portion is 6 GPa to 8 GPa, and
each of a hardness of the first portion, a hardness of the third portion, and a hardness of the fifth portion is 0.8 GPa to 1.0 GPa.

4. The display device of claim 1, wherein
the display device is configured to be folded in a first mode such that
the first folding portion is out-folded and the second folding portion is in-folded, and
the first non-folding portion, the second non-folding portion, and the third non-folding portion overlap, and
the display device is configured to be unfolded in a second mode such that the first non-folding portion, the second non-folding portion, and the third non-folding portion are aligned.

5. The display device of claim 1, wherein in the first coating composition, a first weight of the silsesquioxane-based resin is smaller than a second weight of the oxetane-based resin, and
in the second coating composition, a third weight of the silsesquioxane-based resin is greater than a fourth weight of the oxetane-based resin.

6. The display device of claim 5, wherein a ratio of the first weight to the second weight is 2:8 to 4:6.

7. The display device of claim 5, wherein a ratio of the third weight to the fourth weight is 6:4 to 8:2.

8. The display device of claim 1, wherein based on 100 wt % of a total weight of the first coating composition, a sum of a first weight of the silsesquioxane-based resin and a second weight of the oxetane-based resin is 93 wt % to 95 wt %, and
based on 100 wt % of a total weight of the second coating composition, a sum of a third weight of the silsesquioxane-based resin and a fourth weight of the oxetane-based resin is 93 wt % to 95 wt %.

9. The display device of claim 1, wherein the first portion, the third portion, and the fifth portion each comprise a third polymer derived from a third coating composition, and
the third coating composition comprises the silsesquioxane-based resin, a polymer resin including a radical photopolymerization functional group, a radical photopolymerization initiator, and the silica nanoparticle.

10. The display device of claim 9, wherein the polymer resin including the radical photopolymerization functional group comprises at least one among pentaerythritol tetraacrylate, trimethylolpropane trimethacrylate, and ethylene oxide-modified isocyanurate diacrylate, and
the radical photopolymerization initiator comprises diphenyl(2,4,6-trimethylbenzoyl phosphine) oxide.

11. The display device of claim 9, wherein based on 100 wt % of a total weight of the third coating composition, a sum of a weight of the silsesquioxane-based resin and a weight of the polymer resin including the radical photopolymerization functional group is 93 wt % to 95 wt %.

12. The display device of claim 1, wherein the silsesquioxane-based resin comprises at least one among a partial cage structure, a ladder structure, a random structure, a T₈ cage structure, a T₁₀ cage structure, or a T₁₂ cage structure.

13. The display device of claim 1, wherein the oxetane-based resin comprises at least one among 1,4-bis[(3-ethyl-3-oxetanylmethoxy)methyl]benzene or 2-ethylhexyloxetane, and
the cationic photopolymerization initiator comprises triarylsulfonium hexafluoroantimonate salt.

14. The display device of claim 1, wherein based on 100 wt % of a total weight of the first coating composition, a weight of the cationic photopolymerization initiator is 2 wt % or less, and a weight of the silica nanoparticle is 3 wt % to wt %, and
based on 100 wt % of a total weight of the second coating composition, a weight of the cationic photopolymerization initiator is about 2 wt % or less, and a weight of the silica nanoparticle is 3 wt % to 5 wt %.

15. The display device of claim 1, wherein the silica nanoparticle has a diameter 20 nm to 60 nm.

16. A method for manufacturing a display device, the method comprising:
preparing a display module in which a first non-folding portion, a first folding portion, a second non-folding portion, a second folding portion, and a third non-folding portion are in order along one direction; and
providing a protective member on the display module by
preparing a protective base layer;
providing, on the protective base layer, a hard coating layer having
a first portion formed by providing a first coating composition, the first portion overlapping the first non-folding portion,
a second portion formed by providing a second coating composition, the second portion overlapping the first folding portion,
a third portion formed by providing the first coating composition, the third portion overlapping the second non-folding portion,
a fourth portion formed by providing a third coating composition, the fourth portion overlapping the second folding portion, and
a fifth portion formed by providing the first coating composition, the fifth portion overlapping the third non-folding portion; and
providing, on the hard coating layer, an anti-reflection layer having a high refractive layer and a low refractive layer on the high refractive layer,
wherein each of the second coating composition and the third coating composition includes a silsesquioxane-based resin, an oxetane-based resin, a cationic photopolymerization initiator, and a silica nanoparticle,
wherein the first coating composition, the second coating composition and the third coating composition are provided in a same operation, and
wherein a Young's modulus of the second portion and a hardness of the second portion are respectively smaller than a Young's modulus of the fourth portion and a hardness of the fourth portion.

17. The method of claim 16, wherein the first coating composition, the second coating composition and the third coating composition are provided by a slit coating method.

18. The method of claim 16, wherein in the first coating composition, a first weight of the silsesquioxane-based resin is smaller than a second weight of the oxetane-based resin, and
in the second coating composition, a third weight of the silsesquioxane-based resin is greater than a fourth weight of the oxetane-based resin.

19. The method of claim 16, wherein the first coating composition comprises the silsesquioxane-based resin, a polymer resin including a radical photopolymerization functional group, a radical photopolymerization initiator, and the silica nanoparticle.

20. An electronic apparatus comprising:
a housing; and
a display device including
at least a portion in the housing,
a display module including a first non-folding portion, a first folding portion, a second non-folding portion, a second folding portion, and a third non-folding portion in order along one direction, and
a protective member on the display module, the protective member including
a protective base layer;
a hard coating layer on the protective base layer, the hard coating layer including a first portion overlapping the first non-folding portion, a second portion overlapping the first folding portion, a third portion overlapping the second non-folding portion, a fourth portion overlapping the second folding portion, and a fifth portion overlapping the third non-folding portion; and
an anti-reflection layer on the hard coating layer, the anti-reflection layer including a high refractive layer and a low refractive layer on the high refractive layer,
wherein the second portion includes a first polymer derived from a first coating composition,
wherein the fourth portion includes a second polymer derived from a second coating composition,
wherein each of the first coating composition and the second coating composition includes a silsesquioxane-based resin, an oxetane-based resin, a cationic photopolymerization initiator, and a silica nanoparticle, and
wherein a Young's modulus of the second portion and a hardness of the second portion are respectively smaller than a Young's modulus of the fourth portion and a hardness of the fourth portion.
